(19) United States
(12) Patent Application Publication
(10) Pub. No.: US 2024/0296855 A1
(43) Pub. Date: Sep. 5, 2024

(54) AUDIO CODING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Yuyong KANG, Shenzhen (CN); Meng WANG, Shenzhen (CN); Qingbo HUANG, Shenzhen (CN); Yupeng SHI, Shenzhen (CN); Wei XIAO, Shenzhen (CN)

(21) Appl. No.: 18/646,521

(22) Filed: Apr. 25, 2024

Related U.S. Application Data
(63) Continuation of application No. PCT/CN2023/088014, filed on Apr. 13, 2023.

(30) Foreign Application Priority Data
Jun. 15, 2022 (CN) 202210677636.4

(51) Int. Cl. G10L 19/26; G10L 19/032

(52) U.S. Cl. CPC G10L 19/265; G10L 19/032

(57) ABSTRACT

An audio coding method includes: performing feature extraction on an audio signal at a first layer to obtain a signal feature at the first layer; splicing, for an i^{th} layer among N layers, the audio signal and a signal feature at an (i-1)^{th} layer to obtain a spliced feature, and performing feature extraction on the spliced feature at the i^{th} layer to obtain a signal feature at the i^{th} layer, traversing i^{th} layers of the N layers to obtain a signal feature at each layer among the N layers, and a data dimension of the signal feature being less than a data dimension of the audio signal; and coding the signal feature at the first layer and the signal feature at each layer among the N layers separately to obtain a bitstream of the audio signal at each layer.

### CROSS-REFERENCES TO RELATED APPLICATIONS

This application is a continuation application of PCT Patent Application No. PCT/CN2023/088014, filed on Apr. 13, 2023, which claims priority to Chinese Patent Application No. 202210677636.4 filed on Jun. 15, 2022, all of which is incorporated by reference in their entirety.

### FIELD OF THE TECHNOLOGY

The present disclosure relates to the field of audio processing technologies, and in particular, to an audio coding method and apparatus, an audio decoding method and apparatus, an electronic device, a storage medium, and a computer program product.

### BACKGROUND OF THE DISCLOSURE

The audio coding and decoding technology is a core technology applied to communication services including remote audio and video calls. The audio coding technology is understood as using less network bandwidth resources to transmit as much voice information as possible. Audio coding is a source coding. An objective of the source coding is to reduce an amount of data of information that a user wants to transmit as much as possible on an encoder side, remove redundancy in the information, and restore the redundancy losslessly (or nearly lossless) at a decoder side.

However, audio coding does not provide desirable efficiency for desirable audio coding quality.

### SUMMARY

An embodiment of the present disclosure provides an audio coding method, performed by an electronic device. The method include performing feature extraction on an audio signal at a first layer to obtain a signal feature at the first layer; splicing, for an i^{th} layer among N layers, the audio signal and a signal feature at an (i-1)^{th} layer to obtain a spliced feature, and performing feature extraction on the spliced feature at the i^{th} layer to obtain a signal feature at the i^{th} layer, N and i being integers greater than 1, and i being less than or equal to N; traversing i^{th} layers of the N layers to obtain a signal feature at each layer among the N layers, and a data dimension of the signal feature being less than a data dimension of the audio signal; and coding the signal feature at the first layer and the signal feature at each layer among the N layers separately to obtain a bitstream of the audio signal at each layer.

Another embodiment of the present disclosure provides an electronic device. The electronic device includes one or more processors; and a memory, configured to store executable instructions that, when being executed, cause the one or more processors to perform: performing feature extraction on an audio signal at a first layer to obtain a signal feature at the first layer; splicing, for an i^{th} layer among N layers, the audio signal and a signal feature at an (i-1)^{th} layer to obtain a spliced feature, and performing feature extraction on the spliced feature at the i^{th} layer to obtain a signal feature at the i^{th} layer, N and i being integers greater than 1, and i being less than or equal to N; traversing i^{th} layers of the N layers to obtain a signal feature at each layer among the N layers, and a data dimension of the signal feature being less than a data dimension of the audio signal; and coding the signal feature at the first layer and the signal feature at each layer among the N layers separately to obtain a bitstream of the audio signal at each layer.

Another embodiment of the present disclosure provides a non-transitory computer-readable storage medium, having executable instructions stored thereon that, when being executed, cause the one or more processors to perform: performing feature extraction on an audio signal at a first layer to obtain a signal feature at the first layer; splicing, for an i^{th} layer among N layers, the audio signal and a signal feature at an (i-1)^{th} layer to obtain a spliced feature, and performing feature extraction on the spliced feature at the i^{th} layer to obtain a signal feature at the i^{th} layer, N and i being integers greater than 1, and i being less than or equal to N; traversing i^{th} layers of the N layers to obtain a signal feature at each layer among the N layers, and a data dimension of the signal feature being less than a data dimension of the audio signal; and coding the signal feature at the first layer and the signal feature at each layer among the N layers separately to obtain a bitstream of the audio signal at each layer.

### BRIEF DESCRIPTION OF THE DRAWINGS

FIG. 1 is a schematic diagram of an architecture of an audio coding system according to an embodiment of the present disclosure.

FIG. 2 is a schematic diagram of a structure of an electronic device 500 for performing an audio coding method according to an embodiment of the present disclosure.

FIG. 3 is a schematic flowchart of an audio coding method according to an embodiment of the present disclosure.

FIG. 4 is a schematic flowchart of an audio coding method according to an embodiment of the present disclosure.

FIG. 5 is a schematic flowchart of an audio coding method according to an embodiment of the present disclosure.

FIG. 6 is a schematic flowchart of an audio coding method according to an embodiment of the present disclosure.

FIG. 7 is a schematic flowchart of an audio coding method according to an embodiment of the present disclosure.

FIG. 8 is a schematic flowchart of an audio coding method according to an embodiment of the present disclosure.

FIG. 9 is a schematic flowchart of an audio coding method according to an embodiment of the present disclosure.

FIG. 10 is a schematic flowchart of an audio decoding method according to an embodiment of the present disclosure.

FIG. 11 is a schematic flowchart of an audio decoding method according to an embodiment of the present disclosure.

FIG. 12 is a schematic diagram of spectrum comparison with different bit rates according to an embodiment of the present disclosure.

FIG. 13 is a schematic flowchart of audio coding and audio decoding according to an embodiment of the present disclosure.

FIG. 14 is a schematic diagram of a voice communication link according to an embodiment of the present disclosure.

FIG. 15 is a schematic diagram of a filterbank according to an embodiment of the present disclosure.

FIG. 16A is a schematic diagram of a common convolutional network according to an embodiment of the present disclosure.

FIG. 16B is a schematic diagram of a dilated convolutional network according to an embodiment of the present disclosure.

FIG. 17 is a schematic diagram of a structure of a low-frequency analysis neural network model at a first layer according to an embodiment of the present disclosure.

FIG. 18 is a schematic diagram of a structure of a low-frequency analysis neural network model at a second layer according to an embodiment of the present disclosure.

FIG. 19 is a schematic diagram of a low-frequency synthesis neural network model at a first layer according to an embodiment of the present disclosure.

FIG. 20 is a schematic diagram of a structure of a low-frequency synthesis neural network model at a second layer according to an embodiment of the present disclosure.

### DESCRIPTION OF EMBODIMENTS

To make the objectives, technical solutions, and advantages of the present disclosure clearer, the following describes the present disclosure in detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all suitable embodiments, but it may be understood that “some embodiments” may be the same subset or different subsets of all suitable embodiments, and may be combined with each other without conflict.

In the following description, the term “first/second/third . . . ” is only used for distinguishing similar objects and does not represent a specific order of objects. It may be understood that “first/second/third . . . ” may be interchanged with a specific order or priority if permitted, so that embodiments of the present disclosure described here may be implemented in an order other than that illustrated or described here.

Unless otherwise defined, meanings of all technical and scientific terms used in this specification are the same as those usually understood by a person skilled in the art to which the present disclosure belongs. The terms used herein are only used for describing the objectives of embodiments of the present disclosure, but are not intended to limit the present disclosure.

Before the embodiments of the present disclosure are described in detail, a description is made on terms in the embodiments of the present disclosure, and the terms in the embodiments of the present disclosure are applicable to the following explanations.
(1) Client: It is an application program running in a terminal for providing various services, such as an instant messaging client and an audio playback client.
(2) Audio coding: It is an application of data compression to a digital audio signal including voice.
(3) Quadrature mirror filters (QMF): It is configured to decompose a subband signal into a plurality of signals, so that a signal bandwidth is reduced. The decomposed signals are filtered through respective channels.
(4) Quantization: It is a process of approximating continuous values of a signal (or a large quantity of possible discrete values) into a limited quantity of (or fewer) discrete values, including vector quantization, scalar quantization, and the like.
(5) Vector quantization: It is a process of combining a plurality of scalar data into a vector, dividing vector space into a plurality of small areas, finding a representative vector for each small area, and using a corresponding representative vector to replace a vector that falls into the small area during quantization. In other words, the vector is quantized into the representative vector.
(6) Scalar quantization: It is a process of dividing an entire dynamic range into a plurality of small ranges, and each small range has a representative value. During quantization, a signal value falling into the small range is replaced by a corresponding representative value. In other words, the signal value is quantized into the representative value.
(7) Entropy coding: It is coding that does not lose any information according to the entropy principle during a coding process. Information entropy is an average amount of information in an information source. Common entropy coding includes: Shannon coding, Huffman coding, and arithmetic coding.
(8): Neural network (NN): It is an algorithmic mathematical model that imitates a behavioral feature of an animal neural network and performs distributed parallel information processing. The network relies on complexity of a system to achieve an objective of processing information by adjusting interconnected relationships between a large quantity of internal nodes.
(9): Deep learning (DL): It is a new research direction in the field of machine learning (ML). Deep learning is to learn inherent laws and representation levels of sample data. Information obtained during the learning processes is of great help in interpretation of data such as text, an image, and a sound. An ultimate purpose of the deep learning is to make machines have the same analytical learning capabilities as humans and can recognize data such as a text, an image, and a sound.

Embodiments of the present disclosure provide an audio coding method and apparatus, an audio decoding method and apparatus, an electronic device, a computer-readable storage medium, and a computer program product, which can improve audio coding efficiency and ensure audio coding quality.

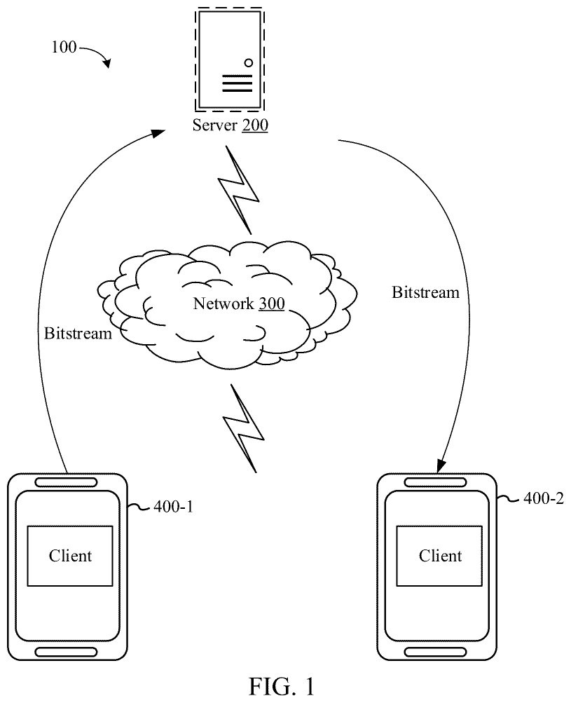

The following describes an implementation scenario of the audio coding method provided in this embodiment of the present disclosure. FIG. 1 is a schematic diagram of an architecture of an audio coding system 100 according to an embodiment of the present disclosure. To support one exemplary application, a terminal (for example, a terminal 400-1 and a terminal 400-2) is connected to a server 200 through a network 300. The network 300 may be a wide area network or a local area network, or a combination thereof. Data transmission may be implemented using wireless or wired links. The terminal 400-1 is a transmit end for an audio signal, and the terminal 400-2 is a receive end for an audio signal.

During a process of the terminal 400-1 sending an audio signal to the terminal 400-2 (such as a process of a remote call between the terminal 400-1 and the terminal 400-2 based on a set client), the terminal 400-1 is configured to: perform feature extraction on the audio signal at a first layer to obtain a signal feature at the first layer; splice, for an i^{th} layer among N layers, the audio signal and a signal feature at an (i-1)^{th} layer to obtain a spliced feature, and perform feature extraction on the spliced feature at the i^{th} layer to obtain a signal feature at the i^{th} layer, N and i being integers greater than 1, and i being less than or equal to N; traverse i^{th} layers of the N layers to obtain a signal feature at each layer among the N layers, and a data dimension of the signal feature being less than a data dimension of the audio signal; code the signal feature at the first layer and the signal feature at each layer among the N layers separately to obtain a bitstream of the audio signal at each layer; and send the bitstream of the audio signal at each layer to the server 200.

The server 200 is configured to: receive bitstreams respectively corresponding to a plurality of layers obtained by coding an audio signal by the terminal 400-1; and send the bitstreams respectively corresponding to the plurality of layers to the terminal 400-2.

The terminal 400-2 is configured to: receive the bitstreams respectively corresponding to the plurality of layers obtained by coding an audio signal sent by the server 200; decode a bitstream at each layer separately to obtain a signal feature at each layer, and a data dimension of the signal feature being less than a data dimension of the audio signal; perform feature reconstruction on the signal feature at each layer separately to obtain a layer audio signal at each layer; and perform audio synthesis on layer audio signals at the plurality of layers to obtain the audio signal.

In some embodiments, the audio coding method provided in this embodiment of the present disclosure may be performed by various electronic devices. For example, the method may be performed by a terminal independently, by a server independently, or by a terminal and a server collaboratively. For example, the terminal performs the audio coding method provided in this embodiment of the present disclosure independently, or the terminal sends a coding request for the audio signal to the server, and the server performs the audio coding method provided in this embodiment of the present disclosure according to the received coding request. Embodiments of the present disclosure may be applied to various scenarios, including but not limited to a cloud technology, artificial intelligence, smart transportation, driver assistance, and the like.

In some embodiments, the electronic device that performs audio coding provided in this embodiment of the present disclosure may be various types of terminal devices or servers. The server (such as the server 200) may be an independent physical server, or may be a server cluster or a distributed system including a plurality of physical servers. The terminal (such as the terminal 400) may be a smartphone, a tablet, a laptop, a desktop computer, an intelligent voice interaction device (such as a smart speaker), a smart home appliance (such as a smart TV), a smart watch, an on-board terminal, and the like, but is not limited thereto. The terminal is directly or indirectly connected to the server via a wired or wireless communication manner. This is not limited in this embodiment of the present disclosure.

In some embodiments, the audio coding method provided in this embodiment of the present disclosure may be implemented with the help of a cloud technology. The cloud technology refers to a hosting technology that integrates resources such as hardware, software, and networks in a wide area network or local area network, to implement data computing, storage, processing and sharing. The cloud technology is a general term of network technologies, information technologies, integration technologies, management platform technologies, application technologies, and the like, applied to a cloud computing business model, and may form a resource pool and be used on demand. This is flexible and convenient. A cloud computing technology is to be an important support. A large amount of computing resources and storage resources are needed for background services in a technical network system. As an example, the foregoing server (such as the server 200) may be a cloud server providing basic cloud computing services, such as a cloud service, a cloud database, cloud computing, a cloud function, cloud storage, a network service, a cloud communication, a middleware service, a domain name service, a security service, a content delivery network (CDN), and a big data and artificial intelligence platform.

In some embodiments, the terminal or the server can implement the audio coding method provided in this embodiment of the present disclosure by running a computer program. For example, the computer program may be a native program or a software module in an operating system; may be a native application (APP), that is, a program that needs to be installed in the operating system to run; or may be a mini program, that is, a program that only needs to be downloaded to a browser environment to run; and may be a mini program that can be embedded in any APP. In conclusion, the foregoing computer program may be any form of application program, module, or plug-in.

In some embodiments, a plurality of servers may form a blockchain, and the servers are nodes on the blockchain. Information connections between the nodes may exist in the blockchain, and information may be transmitted between nodes through the foregoing information connections. Data related to the audio coding method provided in this embodiment of the present disclosure (such as a bitstream of the audio signal at each layer and a neural network model configured to perform feature extraction) may be saved on the blockchain.

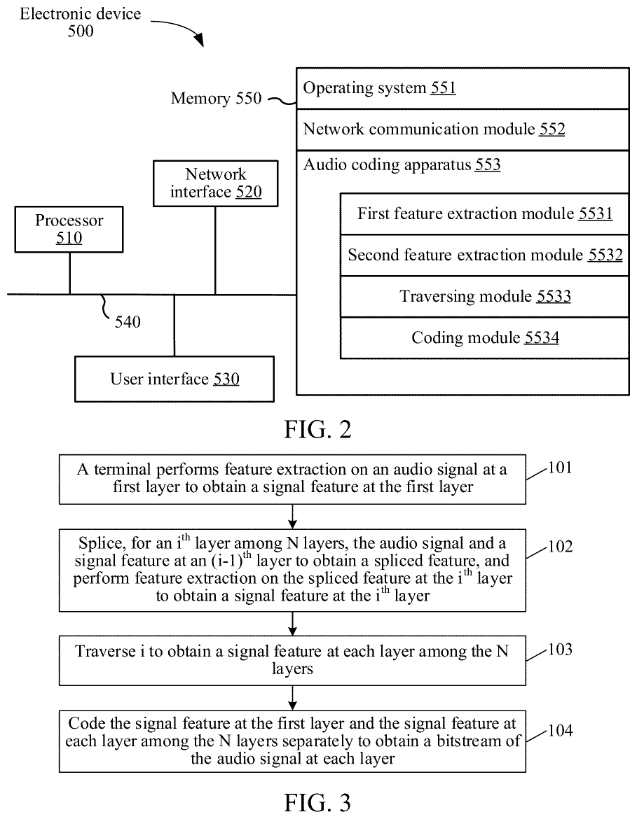

The following describes an electronic device for performing the audio coding method provided in this embodiment of the present disclosure. FIG. 2 is a schematic diagram of a structure of an electronic device 500 for performing an audio coding method according to an embodiment of the present disclosure. An example in which the electronic device 500 is the terminal shown in FIG. 1 (such as the terminal 400-1) is used, the electronic device 500 for performing the audio coding method provided in this embodiment of the present disclosure includes: at least one processor 510, a memory 550, at least one network interface 520, and a user interface 530. Components of the electronic device 500 are coupled together through a bus system 540. It may be understood that, the bus system 540 is configured to implement connections and communication between the components. In addition to a data bus, the bus system 540 also includes a power bus, a control bus, and a status signal bus. However, for clarity, various buses are marked as the bus system 540 in FIG. 2.

The processor 510 may be an integrated circuit chip with a signal processing capability, such as a general-purpose processor, a digital signal processor (DSP), or another programmable logic device, a discrete gate or a transistor logic device, and a discrete hardware component. The general-purpose processor may be a microprocessor or any suitable processor, or the like.

The memory 550 may be removable, non-removable, or a combination thereof. The memory 550 optionally includes one or more storage devices physically away from the processor 510. The memory 550 includes a volatile memory or a non-volatile memory, or may include both volatile memory and non-volatile memory. The non-volatile memory may be a read only memory (ROM), and the volatile memory may be a random access memory (RAM). The memory 550 described in this embodiment of the present disclosure is intended to include any suitable type of memories.

In some embodiments, the memory 550 can store data to support various operations, examples of the data include a program, a module, and a data structure, or a subset or superset thereof, which are described below by using examples.

An operating system 551 includes a system program configured to process various basic system services and perform hardware-related tasks, such as a framework layer, a core library layer, and a driver layer, and the operating system 551 is configured to implement various basic services and process hardware-based tasks.

A network communication module 552 is configured to reach another computing device via one or more (wired or wireless) network interfaces 520. For example, the network interface 520 includes: Bluetooth, wireless fidelity (Wi-Fi), a universal serial bus (USB), and the like.

In some embodiments, an audio coding apparatus provided in an embodiment of the present disclosure may be implemented by software. FIG. 2 shows an audio coding apparatus 553 stored in the memory 550. The audio coding apparatus 553 may be software in the form of a program and plug-in, and includes the following software modules: a first feature extraction module 5531, a second feature extraction module 5532, a traversing module 5533, and a coding module 5534. The modules are logical. Therefore, arbitrary combination or splitting may be performed according to achieved functions. The functions of the modules are described below.

The following describes the audio coding method provided in this embodiment of the present disclosure. In some embodiments, the audio coding method provided in this embodiment of the present disclosure may be performed by various electronic devices. For example, the method may be performed by a terminal independently, by a server independently, or by a terminal and a server collaboratively. An example in which the method is performed by a terminal is used, FIG. 3 is a schematic flowchart of an audio coding method according to an embodiment of the present disclosure. The audio coding method provided in this embodiment of the present disclosure includes:

Step 101: A terminal performs feature extraction on an audio signal at a first layer to obtain a signal feature at the first layer.

In an exemplary embodiment, the audio signal may be a voice signal during a call (such as an Internet call and a phone call), a voice message (such as a voice message sent in an instant messaging client), played music, audio, and the like. An audio signal needs to be coded during transmission of the audio signal, so that a transmit end for the audio signal may transmit a coded bitstream, and a receive end for the bitstream may decode the received bitstream to obtain the audio signal. The following describes a coding process of the audio signal. In this embodiment of the present disclosure, the audio signal is coded in a hierarchical coding manner. The hierarchical coding manner is implemented by coding the audio signal at a plurality of layers. The following describes a coding process at each layer. First, for the first layer, the terminal may perform feature extraction on the audio signal at the first layer to obtain a signal feature of the audio signal extracted from the first layer, that is, a signal feature at the first layer.

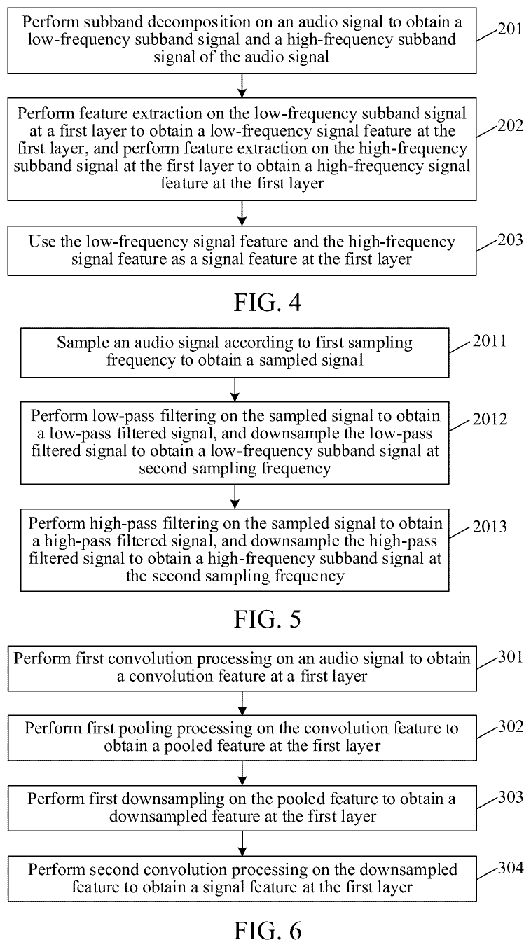

In some embodiments, the audio signal includes a low-frequency subband signal and a high-frequency subband signal. When the audio signal is processed (such as feature extraction and coding), the low-frequency subband signal and the high-frequency subband signal included in the audio signal may be processed separately. Based on this, FIG. 4 is a schematic flowchart of an audio coding method according to an embodiment of the present disclosure. FIG. 4 shows that step 101 in FIG. 3 may be implemented by step 201 to step 203. Step 201: Perform subband decomposition on the audio signal to obtain the low-frequency subband signal and the high-frequency subband signal of the audio signal. Step 202: Perform feature extraction on the low-frequency subband signal at the first layer to obtain a low-frequency signal feature at the first layer, and perform feature extraction on the high-frequency subband signal at the first layer to obtain a high-frequency signal feature at the first layer. Step 203: Use the low-frequency signal feature and the high-frequency signal feature as the signal feature at the first layer.

In step 201, during the feature extraction process of the audio signal at the first layer, the terminal may first perform subband decomposition on the audio signal to obtain the low-frequency subband signal and the high-frequency subband signal of the audio signal, then perform feature extraction on the low-frequency subband signal and the high-frequency subband signal respectively. In some embodiments, FIG. 5 is a schematic flowchart of an audio coding method according to an embodiment of the present disclosure. FIG. 5 shows that step 201 in FIG. 4 may be implemented by step 2011 to step 2013. Step 2011: Sample the audio signal according to first sampling frequency to obtain a sampled signal. Step 2012: Perform low-pass filtering on the sampled signal to obtain a low-pass filtered signal, and downsample the low-pass filtered signal to obtain the low-frequency subband signal at second sampling frequency. Step 2013: Perform high-pass filtering on the sampled signal to obtain a high-pass filtered signal, and downsample the high-pass filtered signal to obtain the high-frequency subband signal at second sampling frequency. The second sampling frequency is less than the first sampling frequency.

In step 2011, the audio signal may be sampled according to the first sampling frequency to obtain the sampled signal, and the first sampling frequency may be preset. In an exemplary embodiment, the audio signal is a continuous analog signal. The audio signal is sampled by using the first sampling frequency, to obtain a discrete digital signal, that is, a sampled signal. The sampled signal includes a plurality of sample points (that is, sampled values) sampled from the audio signal.

In step 2012, the low-pass filtering is performed on the sampled signal to obtain the low-pass filtered signal, and the low-pass filtered signal is downsampled to obtain the low-frequency subband signal at the second sampling frequency. In step 2013, the high-pass filtering is performed on the sampled signal to obtain the high-pass filtered signal, and the high-pass filtered signal is downsampled to obtain the high-frequency subband signal at the second sampling frequency. In steps 202 and 203, the low-pass filtering and the high-pass filtering may be implemented by a QMF analysis filter. In an actual implementation, the second sampling frequency may be half of the first sampling frequency, so that a low-frequency subband signal and a high-frequency subband signal at the same frequency can be obtained.

In step 202, after the low-frequency subband signal and the high-frequency subband signal of the audio signal are obtained, feature extraction is performed on the low-frequency subband signal of the audio signal at the first layer to obtain the low-frequency signal feature at the first layer, and feature extraction is performed on the high-frequency subband signal at the first layer to obtain the high-frequency signal feature at the first layer. In step 203, the low-frequency signal feature and the high-frequency signal feature are used as the signal feature at the first layer.

In some embodiments, FIG. 6 is a schematic flowchart of an audio coding method according to an embodiment of the present disclosure. FIG. 6 shows that step 101 in FIG. 3 may alternatively be implemented by step 301 to step 304. Step 301: Perform first convolution processing on the audio signal to obtain a convolution feature at the first layer. Step 302: Perform first pooling processing on the convolution feature to obtain a pooled feature at the first layer. Step 303: Perform first downsampling on the pooled feature to obtain a downsampled feature at the first layer. Step 304: Perform second convolution processing on the downsampled feature to obtain the signal feature at the first layer.

In step 301, the first convolution processing may be performed on the audio signal. In an exemplary embodiment, the first convolution processing may be processed by calling a causal convolution with a preset quantity of channels (such as 24 channels), so that the convolution feature at the first layer is obtained.

In step 302, the first pooling processing is performed on the convolution feature obtained in step 301. In an exemplary embodiment, during the first pooling processing, a pooling factor (such as 2) may be preset, so that the pooled feature at the first layer is obtained by performing the first pooling processing on the convolution feature based on the pooling factor.

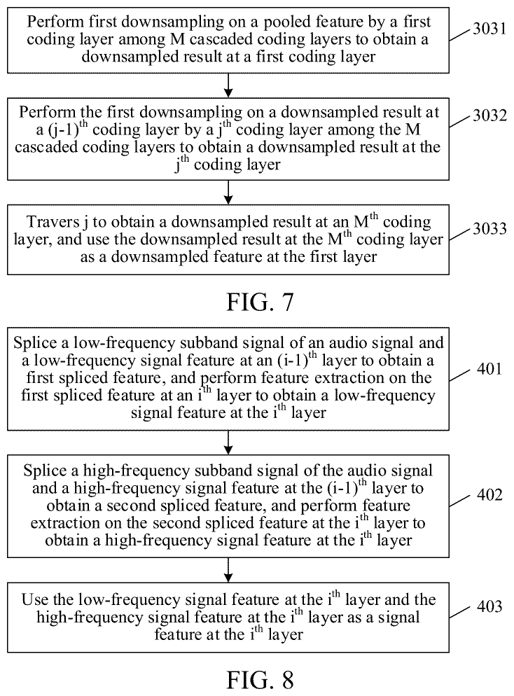

In step 303, the first downsampling is performed on the pooled feature obtained in step 302. In an exemplary embodiment, a downsampling factor may be preset, so that downsampling is performed based on the downsampling factor. The first downsampling may be implemented by one coding layer or by a plurality of coding layers. In some embodiments, the first downsampling is performed by M cascaded coding layers. Correspondingly, FIG. 7 is a schematic flowchart of an audio coding method according to an embodiment of the present disclosure. FIG. 7 shows that step 303 in FIG. 6 may alternatively be implemented by step 3031 to step 3033. Step 3031: Perform the first downsampling on the pooled feature by a first coding layer among the M cascaded coding layers to obtain a downsampled result at the first coding layer. Step 3032: Perform the first downsampling on a downsampled result at a (j-1)^{th} coding layer by a j^{th} coding layer among the M cascaded coding layers to obtain a downsampled result at the j^{th} coding layer. M and j are integers greater than 1, j is less than or equal to M. Step 3033: Travers j to obtain a downsampled result at an M^{th} coding layer, and use the downsampled result at an M^{th} coding layer as the downsampled feature at the first layer.

In step 3031 to step 3033, the downsampling factor at each coding layer may be the same or different. In an exemplary embodiment, the downsampling factor is equivalent to the pooling factor and plays a role of down-sampling.

In step 304, the second convolution processing may be performed on the downsampled feature. In an exemplary embodiment, the second convolution processing may be processed by calling a causal convolution with a preset quantity of channels, so that the signal feature at the first layer is obtained.

In an exemplary embodiment, step 301 to step 304 shown in FIG. 6 may be implemented by calling a first neural network model. The first neural network model includes a first convolution layer, a pooling layer, a downsampling layer, and a second convolution layer. In this way, the convolution feature at the first layer can be obtained by calling the first convolution layer to perform the first convolution processing on the audio signal. The pooled feature at the first layer can be obtained by calling the pooling layer to perform the first pooling processing on the convolution feature. The downsampled feature at the first layer can be obtained by calling the downsampling layer to perform the first downsampling on the pooled feature. The signal feature at the first layer can be obtained by calling the second convolution layer to perform the second convolution processing on the downsampled feature.

When the feature extraction is performed on the audio signal at the first layer, the feature extraction is performed on the low-frequency subband signal and the high-frequency subband signal of the audio signal at the first layer separately by step 301 to step 304 shown in FIG. 6 (that is, step 202 shown in FIG. 4). In other words, the first convolution processing is performed on the low-frequency subband signal of the audio signal to obtain a first convolution feature at the first layer. The first pooling processing is performed on the first convolution feature to obtain a first pooled feature at the first layer. The first downsampling is performed on the first pooled feature to obtain a first downsampled feature at the first layer. The second convolution processing is performed on the first downsampled feature to obtain the low-frequency signal feature at the first layer. The first convolution processing is performed on the high-frequency subband signal of the audio signal to obtain a second convolution feature at the first layer. The first pooling processing is performed on the second convolution feature to obtain a second pooled feature at the first layer. The first downsampling is performed on the second pooled feature to obtain a second downsampled feature at the first layer. The second convolution processing is performed on the second downsampled feature to obtain the high-frequency signal feature at the first layer.

Step 102: Splice, for an i^{th} layer among N layers, the audio signal and a signal feature at an (i-1)^{th} layer to obtain a spliced feature, and perform feature extraction on the spliced feature at the i^{th} layer to obtain a signal feature at the i^{th} layer.

N and i are integers greater than 1, and i is less than or equal to N.

After the feature extraction is performed on the audio signal at the first layer, feature extraction may also be performed on the audio signal at remaining layers. In this embodiment of the present disclosure, the remaining layers include N layers, for the i^{th} layer among the N layers, the audio signal and the signal feature at the (i-1)^{th} layer are spliced to obtain the spliced feature, and the feature extraction is performed on the spliced feature at the i^{th} layer to obtain the signal feature at the i^{th} layer. For example, for a second layer, the audio signal and the signal feature at the first layer are spliced to obtain a spliced feature, and feature extraction is performed on the spliced feature at the second layer to obtain a signal feature at the second layer. For a third layer, the audio signal and the signal feature at the second layer are spliced to obtain a spliced feature, and feature extraction is performed on the spliced feature at the third layer to obtain a signal feature at the third layer. For a fourth layer, the audio signal and the signal feature at the third layer are spliced to obtain a spliced feature, and feature extraction is performed on the spliced feature at the fourth layer to obtain a signal feature at the fourth layer, and the like.

In some embodiments, the audio signal includes a low-frequency subband signal and a high-frequency subband signal. When the audio signal is processed (such as feature extraction and coding), the low-frequency subband signal and the high-frequency subband signal included in the audio signal may be processed separately. Based on this, for the i^{th} layer among the N layers, subband decomposition may also be performed on the audio signal to obtain the low-frequency subband signal and the high-frequency subband signal of the audio signal. A process of the subband decomposition may be referred to the foregoing step 2011 to step 2013. In this way, for the i^{th} layer among the N layers, data outputted by performing the feature extraction includes: a low-frequency signal feature at the i^{th} layer and a high-frequency signal feature at the i^{th} layer.

FIG. 8 is a schematic flowchart of an audio coding method according to an embodiment of the present disclosure. FIG. 8 shows that step 102 in FIG. 3 may be implemented by step 401 to step 403. Step 401: Splice the low-frequency subband signal of the audio signal and a low-frequency signal feature at the (i-1)^{th} layer to obtain a first spliced feature, and perform feature extraction on the first spliced feature at the i^{th} layer to obtain a low-frequency signal feature at the i^{th} layer. Step 402: Splice the high-frequency subband signal of the audio signal and a high-frequency signal feature at the (i-1)^{th} layer to obtain a second spliced feature, and perform feature extraction on the second spliced feature at the i^{th} layer to obtain a high-frequency signal feature at the i^{th} layer. Step 403: Use the low-frequency signal feature at the i^{th} layer and the high-frequency signal feature at the i^{th} layer as the signal feature at the i^{th} layer.

In step 401, after the low-frequency subband signal and the high-frequency subband signal of the audio signal are obtained, the low-frequency subband signal of the audio signal and the low-frequency signal feature extracted from the (i-1)^{th} layer are spliced to obtain the first spliced feature, and the feature extraction is performed on the first spliced feature at the i^{th} layer to obtain the low-frequency signal feature at the i^{th} layer. Similarly, in step 402, the high-frequency subband signal of the audio signal and the high-frequency signal feature extracted from the (i-1)^{th} layer are spliced to obtain the second spliced feature, and the feature extraction is performed on the second spliced feature at the i^{th} layer to obtain the high-frequency signal feature at the i^{th} layer. In this way, in step 403, the low-frequency signal feature at the i^{th} layer and the high-frequency signal feature at the i^{th} layer are used as the signal feature at the i^{th} layer.

FIG. 9 is a schematic flowchart of an audio coding method according to an embodiment of the present disclosure. FIG. 9 shows that step 102 in FIG. 3 may alternatively be implemented by step 501 to step 504. Step 501: Perform third convolution processing on the spliced feature to obtain a convolution feature at the i^{th} layer. Step 502: Perform second pooling processing on the convolution feature to obtain a pooled feature at the i^{th} layer. Step 503: Perform second downsampling on the pooled feature to obtain a downsampled feature at the i ^{th}layer. Step 504: Perform fourth convolution processing on the downsampled feature to obtain the signal feature at the i^{th} layer.

In step 501, the third convolution processing may be performed on the spliced feature (obtained by splicing the audio signal and the signal feature at the (i-1)^{th} layer). In an exemplary embodiment, the third convolution processing may be processed by calling a causal convolution with a preset quantity of channels, so that the convolution feature at the i^{th} layer is obtained.

In step 502, the second pooling processing is performed on the convolution feature obtained in step 501. In an exemplary embodiment, during the second pooling processing, a pooling factor may be preset, so that the pooled feature at the i^{th} layer is obtained by performing the second pooling processing on the convolution feature based on the pooling factor.

In step 503, the second downsampling is performed on the pooled feature obtained in step 502. In an exemplary embodiment, a downsampling factor may be preset, so that downsampling is performed based on the downsampling factor. The second downsampling may be performed by one coding layer or by a plurality of coding layers. In some embodiments, the second downsampling may be performed by X cascaded coding layers. Correspondingly, step 503 in FIG. 9 may alternatively be implemented by step 5031 to step 5033. Step 5031: Perform second downsampling on the pooled feature by a first coding layer among the X cascaded coding layers to obtain a downsampled result at the first coding layer. Step 5032: Perform second downsampling on a downsampled result at a (g-1)^{th} coding layer by a g^{th} coding layer among the X cascaded coding layers to obtain a downsampled result at the g^{th} coding layer. X and g are integers greater than 1, and g is less than or equal to X. Step 5033: Traverse g to obtain a downsampled result at an X^{th} coding layer, and use the downsampled result at the X^{th} coding layer as the downsampled feature at the i^{th} layer.

In step 5031 to step 5033, the downsampling factor at each coding layer may be the same or different. In an exemplary embodiment, the downsampling factor is equivalent to the pooling factor and plays a role of down-sampling.

In step 504, the fourth convolution processing may be performed on the downsampled feature. In an exemplary embodiment, the fourth convolution processing may be processed by calling a causal convolution with a preset quantity of channels, so that the signal feature at the i^{th} layer is obtained.

In an exemplary embodiment, step 501 to step 504 shown in FIG. 9 may be implemented by calling a second neural network model. The second neural network model includes a third convolution layer, a pooling layer, a downsampling layer, and a fourth convolution layer. In this way, the convolution feature at the i^{th} layer can be obtained by calling the third convolution layer to perform the third convolution processing on the spliced feature. The pooled feature at the i^{th} layer can be obtained by calling the pooling layer to perform the second pooling processing on the convolution feature. The downsampled feature at the i^{th} layer can be obtained by calling the downsampling layer to perform the second downsampling on the pooled feature. The signal feature at the i^{th} layer can be obtained by calling the fourth convolution layer to perform the fourth convolution processing on the downsampled feature. In an actual implementation, a feature dimension of a signal feature outputted by a second neural network may be less than a feature dimension of a signal feature inputted by a first neural network.

When the feature extraction is performed at the i^{th} layer, the feature extraction is performed on the low-frequency subband signal and the high-frequency subband signal of the audio signal at the i^{th} layer separately by step 501 to step 504 shown in FIG. 9. In other words, for the i^{th} layer, the third convolution processing is performed on a low-frequency spliced feature (obtained by splicing the low-frequency subband signal and the low-frequency signal feature at the (i-1)^{th} layer) to obtain the convolution feature at the i^{th} layer, and the second pooling processing is performed on the convolution feature to obtain the pooled feature at the i^{th} layer. The second downsampling is performed on the pooled feature to obtain the downsampled feature at the i^{th} layer. The fourth convolution processing is performed on the downsampled feature to obtain the low-frequency signal feature at the i^{th} layer. For the i^{th} layer, the third convolution processing is performed on a high-frequency spliced feature (obtained by splicing the high-frequency subband signal and the high-frequency signal feature at the (i-1)^{th} layer) to obtain the convolution feature at the i^{th} layer. The second pooling processing is performed on the convolution feature to obtain the pooled feature at the i^{th} layer. The second downsampling is performed on the pooled feature to obtain the downsampled feature at the i^{th} layer. The fourth convolution processing is performed on the downsampled feature to obtain the high-frequency signal feature at the i^{th} layer.

Step 103: Traverse i^{th} layers of the N layers to obtain a signal feature at each layer among the N layers.

A data dimension of the signal feature is less than a data dimension of the audio signal.

In step 102, the feature extraction process for the i^{th} layer is described. In an exemplary embodiment, i needs to be traversed to obtain the signal feature at each layer among the N layers. In this embodiment of the present disclosure, the data dimension of the signal feature outputted at each layer is less than the data dimension of the audio signal. In this way, the data dimension of data in an audio coding process can be reduced and coding efficiency of the audio coding can be improved.

Step 104: code the signal feature at the first layer and the signal feature at each layer among the N layers separately to obtain a bitstream of the audio signal at each layer.

In an exemplary embodiment, after the signal feature at the first layer and the signal feature at each layer among the N layers are obtained, the signal feature at the first layer and the signal feature at each layer among the N layers are coded separately to obtain the bitstream of the audio signal at each layer. The bitstream may be transmitted to a receive end for the audio signal, so that the receive end serves as a decoder side to decode the audio signal.

The signal feature outputted at the i^{th} layer among the N layers may be understood as a residual signal feature between the signal feature outputted at the (i-1)^{th} layer and an original audio signal. In this way, the extracted signal feature of the audio signal includes not only the signal feature of the audio signal extracted at the first layer, but also a residual signal feature extracted at each layer among the N layers, so that the extracted signal feature of the audio signal is more comprehensive and accurate, and an information loss of the audio signal in the feature extraction process is reduced. Therefore, when the signal feature at the first layer and the signal feature at each layer among the N layers are coded separately, quality of a bitstream obtained by coding is better, and information of the audio signal included is closer to the original audio signal, so that coding quality of the audio coding is improved.

In some embodiments, step 104 in FIG. 3 may be implemented by step 104a1 and step 104a2. Step 104a1: Quantize the signal feature at the first layer and the signal feature at each layer among the N layers separately to obtain a quantized result of a signal feature at each layer. Step 104a2: Perform entropy coding on the quantized result of the signal feature at each layer to obtain the bitstream of the audio signal at each layer.

In step 104a1, a quantization table may be preset, and the quantization table includes a correspondence between the signal feature and a quantized value. When the quantization is performed, corresponding quantized values can be queried for the signal feature at the first layer and the signal feature at each layer among the N layers separately by querying the preset quantization table, so that the queried quantized values are used as quantized results. In step 104a2, the entropy coding is performed on the quantized result of the signal feature at each layer separately to obtain the bitstream of the audio signal at each layer.

In an exemplary embodiment, the audio signal includes the low-frequency subband signal and the high-frequency subband signal. Correspondingly, the signal feature outputted at each layer includes a low-frequency signal feature and a high-frequency signal feature. Based on this, when the signal feature includes the low-frequency signal feature and the high-frequency signal feature, in some embodiments, step 104 in FIG. 3 may alternatively be implemented by step 104b1 to step 104b3. Step 104b1: Code a low-frequency signal feature at the first layer and a low-frequency signal feature at each layer among the N layers separately to obtain a low-frequency bitstream of the audio signal at each layer. Step 104b2: Code a high-frequency signal feature at the first layer and a high-frequency signal feature at each layer among the N layers separately to obtain a high-frequency bitstream of the audio signal at each layer. Step 104b3: Use the low-frequency bitstream and the high-frequency bitstream of the audio signal at each layer as a bitstream of the audio signal at a corresponding layer.

The coding process of the low-frequency signal feature in step 104b1 may alternatively be implemented by steps similar to step 104a1 and step 104a2, to be specific, the low-frequency signal feature at the first layer and the low-frequency signal feature at each layer among the N layers are quantized separately to obtain a quantized result of a low-frequency signal feature at each layer. Entropy coding is performed on the quantized result of the low-frequency signal feature at each layer to obtain the low-frequency bitstream of the audio signal at each layer. The coding process of the high-frequency signal feature in step 104b2 may alternatively be implemented by steps similar to step 104a1 and step 104a2, to be specific, the high-frequency signal feature at the first layer and the high-frequency signal feature at each layer among the N layers are quantized separately to obtain a quantized result of a high-frequency signal feature at each layer. Entropy coding is performed on the quantized result of a high-frequency signal feature at each layer to obtain the high-frequency bitstream of the audio signal at each layer.

In an exemplary embodiment, the audio signal includes the low-frequency subband signal and the high-frequency subband signal. Correspondingly, the signal feature outputted at each layer includes a low-frequency signal feature and a high-frequency signal feature. Based on this, when the signal feature includes the low-frequency signal feature and the high-frequency signal feature, in some embodiments, step 104 in FIG. 3 may alternatively be implemented by step 104c1 to step 104c3. Step 104c1: Code a low-frequency signal feature at the first layer according to a first coding bit rate to obtain a first bitstream at the first layer, and code a high-frequency signal feature at the first layer according to a second coding bit rate to obtain a second bitstream at the first layer. Step 104c2: Perform the following processing separately for the signal feature at each layer among the N layers: coding the signal feature at each layer separately according to a third coding bit rate at each layer to obtain a second bitstream at each layer. Step 104c3: Use the second bitstream at the first layer and the second bitstream at each layer among the N layers as the bitstream of the audio signal at each layer.

The first coding bit rate is greater than the second coding bit rate, and the second coding bit rate is greater than the third coding bit rate of any layer among the N layers. A coding bit rate of the layer is positively correlated with a decoding quality indicator of a bitstream of a corresponding layer. In step 104c2, a corresponding third coding bit rate may be set for each layer among the N layers. The third coding bit rate at each layer among the N layers may be the same, may be partially the same and partially different, or may be completely different. A coding bit rate of a layer is positively correlated with a decoding quality indicator of a bitstream of a corresponding layer, to be specific, a greater coding bit rate indicates a greater (value of) a decoding quality indicator of the bitstream. The low-frequency signal feature at the first layer includes the most features of the audio signal. Therefore, the first coding bit rate used for the low-frequency signal feature at the first layer is the greatest to ensure a coding effect of the audio signal. In addition, for the high-frequency signal feature at the first layer, the second coding bit rate lower than the first coding bit rate is used for coding, and for the signal feature at each layer among the N layers, the third coding bit rate lower than the second coding bit rate is used for coding. While more features of the audio signal (including a high-frequency signal feature and a residual signal feature) are added, coding efficiency of the audio signal is improved by properly allocating a coding bit rate at each layer.

In some embodiments, after the bitstream of the audio signal at each layer is obtained, the terminal may also perform the following processing separately for each layer. A corresponding layer transmission priority is configured for the bitstream of the audio signal at the layer. The layer transmission priority is negatively correlated with a layer level, and the layer transmission priority is positively correlated with a decoding quality indicator of a bitstream of a corresponding layer.

The layer transmission priority of the layer is used for representing a transmission priority of a bitstream at the layer. The layer transmission priority is negatively correlated with the layer level, to be specific, a higher layer level indicates a lower layer transmission priority of the corresponding layer. For example, a layer transmission priority of the first layer (where the layer level is one) is higher than a layer transmission priority of the second layer (where the layer level is two). Based on this, when the bitstream at each layer is transmitted to a decoder side, the bitstream at the corresponding layer may be transmitted according to the configured layer transmission priority. In an exemplary embodiment, when bitstreams of the audio signal at a plurality of layers are transmitted to the decoder side, bitstreams at some layers may be transmitted, or bitstreams at all layers may be transmitted. When the bitstreams at some layers are transmitted, a bitstream at a corresponding layer may be transmitted according to the configured layer transmission priority.

In some embodiments, the signal feature includes the low-frequency signal feature and the high-frequency signal feature, and the bitstream of the audio signal at each layer includes: a low-frequency bitstream obtained by coding based on the low-frequency signal feature and a high-frequency bitstream obtained by coding based on the high-frequency signal feature. After obtaining the bitstream of the audio signal at each layer, the terminal may also perform the following processing separately for each layer. A first transmission priority is configured for the low-frequency bitstream at the layer, and a second transmission priority is configured for the high-frequency bitstream at the layer. The first transmission priority is higher than the second transmission priority, the second transmission priority at the (i-1)^{th} layer is lower than the first transmission priority at the i^{th} layer, and a transmission priority of the bitstream is positively correlated with a decoding quality indicator of a corresponding bitstream.

Because the transmission priority of the bitstream is positively correlated with the decoding quality indicator of the corresponding bitstream, and because a data dimension of the high-frequency bitstream is less than a data dimension of the low-frequency bitstream, original information of the audio signal included in the low-frequency bitstream at each layer is more than original information of the audio signal included in the high-frequency bitstream. In other words, to ensure that a decoding quality indicator of the low-frequency bitstream is higher than a decoding quality indicator of the high-frequency bitstream, the first transmission priority is configured for the low-frequency bitstream at the layer, and the second transmission priority is configured for the high-frequency bitstream at the layer for each layer, and the first transmission priority is higher than the second transmission priority. In addition, the second transmission priority at the (i-1)^{th} layer is configured to be lower than the first transmission priority at the i^{th} layer. In other words, for each layer, the transmission priority of the low-frequency bitstream is higher than the transmission priority of the high-frequency bitstream. In this way, it is ensured that the low-frequency bitstream at each layer can be preferentially transmitted. For a plurality of layers, the transmission priority of the low-frequency bitstream at the i^{th} layer is higher than the transmission priority of the high-frequency bitstream at the (i-1)^{th} layer. In this way, it is ensured that all low-frequency bitstreams at the plurality of layers can be preferentially transmitted.

Hierarchical coding of the audio signal can be implemented by using the embodiments of the present disclosure. First, the feature extraction is performed on the audio signal at the first layer to obtain the signal feature at the first layer. Then, for the i^{th} (where i is an integer greater than 1, and i is less than or equal to N) layer among the N (where N is an integer greater than 1) layers, the audio signal and the signal feature at the (i-1)^{th} layer are spliced to obtain the spliced feature, and the feature extraction is performed on the spliced feature at the i^{th} layer to obtain the signal feature at the i^{th} layer. Next, i is traversed to obtain the signal feature at each layer among the N layers. Finally, the signal feature at the first layer and the signal feature at each layer among the N layers are coded separately to obtain the bitstream of the audio signal at each layer.

A signal feature at each layer is obtained by coding an audio signal hierarchically. Because a data dimension of the signal feature at each layer is less than a data dimension of the audio signal, a data dimension of data processed in an audio coding process is reduced and coding efficiency of the audio signal is improved.

When a signal feature of the audio signal is extracted hierarchically, output at each layer is used as input at the next layer, so that each level is enabled to combine a signal feature extracted from the previous layer to perform more accurate feature extraction on the audio signal. As a quantity of layers increases, an information loss of the audio signal during a feature extraction process can be minimized. In this way, audio signal information included in a plurality of bitstreams obtained by coding the signal feature extracted in this manner is close to an original audio signal, so that an information loss of the audio signal during a coding process is reduced, and coding quality of audio coding is ensured.

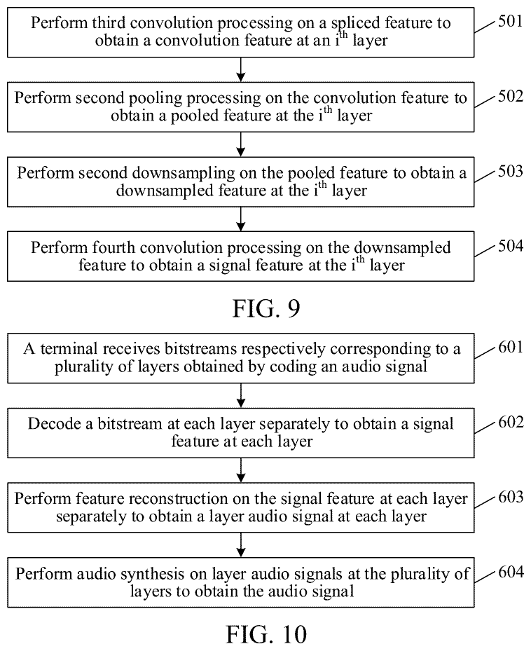

The following describes an audio decoding method provided in this embodiment of the present disclosure. In some embodiments, the audio decoding method provided in this embodiment of the present disclosure may be performed by various electronic devices. For example, the method may be performed by a terminal independently, by a server independently, or by a terminal and a server collaboratively. An example in which the method is performed by a terminal is used, FIG. 10 is a schematic flowchart of an audio decoding method according to an embodiment of the present disclosure. The audio decoding method provided in this embodiment of the present disclosure includes:

Step 601: A terminal receives bitstreams respectively corresponding to a plurality of layers obtained by coding an audio signal.

The terminal here serves as a decoder side and receives the bitstreams corresponding to the plurality of layers obtained by coding the audio signal.

Step 602: Decode a bitstream at each layer separately to obtain a signal feature at each layer.

A data dimension of the signal feature is less than a data dimension of the audio signal.

In some embodiments, the terminal may decode the bitstreams at each layer separately in the following manner to obtain the signal feature at each layer. For each layer, the following processing is performed separately: Performing entropy decoding on the bitstream at the layer to obtain a quantized value of the bitstream; and performing inverse quantization processing on the quantized value of the bitstream to obtain the signal feature at the layer.

In an exemplary embodiment, the following processing may be performed separately for the bitstream at each layer: Performing entropy decoding on the bitstream at the layer to obtain the quantized value of the bitstream; and performing inverse quantization processing on the quantized value of the bitstream based on a quantization table used in a process of coding the audio signal to obtain the bitstream. In other words, the signal feature corresponding to the quantized value of the bitstream is queried by using the quantization table to obtain the signal feature at the layer.

In an exemplary embodiment, the received bitstream at each layer may include a low-frequency bitstream and a high-frequency bitstream. The low-frequency bitstream is coded based on a low-frequency signal feature of the audio signal, and the high-frequency bitstream is coded based on a high-frequency signal feature of the audio signal. In this way, when the bitstream at each layer is decoded, the low-frequency bitstream and the high-frequency bitstream at each layer may be decoded separately. A decoding process of the high-frequency bitstream and the low-frequency bitstream is similar to a decoding process of the bitstream. To be specific, for the low-frequency bitstream at each layer, the following processing is performed separately: Performing entropy decoding on the low-frequency bitstream at the layer to obtain a quantized value of the low-frequency bitstream; and performing inverse quantization processing on the quantized value of the low-frequency bitstream to obtain the low-frequency signal feature at the layer. For the high-frequency bitstream at each layer, the following processing is performed separately: Performing entropy decoding is on the high-frequency bitstream at the layer to obtain a quantized value of the high-frequency bitstream; and performing inverse quantization processing on the quantized value of the high-frequency bitstream to obtain the high-frequency signal feature at the layer.

Step 603: Perform feature reconstruction on the signal feature at each layer separately to obtain a layer audio signal at each layer.

In an exemplary embodiment, after the signal feature at each layer is obtained by decoding, the feature reconstruction is performed on the signal feature at each layer separately to obtain the layer audio signal at each layer. In some embodiments, the terminal may perform the feature reconstruction on the signal feature at each layer in the following manner to obtain the layer audio signal at each layer. For the signal feature at each layer, the following processing is performed separately: Performing first convolution processing on the signal feature to obtain a convolution feature at the layer; upsampling the convolution feature to obtain an upsampled feature at the layer; performing pooling processing on the upsampled feature to obtain a pooled feature at the layer; and performing second convolution processing on the pooled feature to obtain the layer audio signal at the layer.

In an exemplary embodiment, for the signal feature at each layer, the following processing is performed separately: Performing the first convolution processing on the signal feature first, and the first convolution processing may be processed by calling a causal convolution with a preset quantity of channels, so that the convolution feature at the layer is obtained; upsampling the convolution feature then, and an upsampling factor may be preset, so that an upsampled feature at the layer is obtained by upsampling based on the upsampling factor; performing the pooling processing on the upsampled feature next, during the pooling processing, a pooling factor may be preset, so that the pooled feature at the layer is obtained by performing the pooling processing on the upsampled feature based on the pooling factor; and performing the second convolution processing on the pooled feature, and the second convolution processing may be processed by calling a causal convolution with a preset quantity of channels, so that the layer audio signal at the layer is obtained.

The upsampling may be performed by one decoding layer or by a plurality of decoding layers. When the upsampling may be performed by L (L>1) cascaded decoding layers, the terminal may upsample the convolution feature in the following manner to obtain the upsampled feature at the layer: Upsampling the pooled feature by a first decoding layer among the L cascaded decoding layers to obtain an upsampled result at the first decoding layer; upsampling a first upsampled result at a (k-1)^{th} decoding layer by a kth decoding layer among the L cascaded decoding layers to obtain an upsampled result at the k^{th} decoding layer, L and k being integers greater than 1, and k being less than or equal to L; and traversing k to obtain an upsampled result of an L^{th} decoding layer, and using the upsampled result of an L^{th} decoding layer as the upsampled feature at the layer.

An upsampling factor at each decoding layer may be the same or different.

Step 604: Perform audio synthesis on layer audio signals at the plurality of layers to obtain the audio signal.

In an exemplary embodiment, after a layer audio signal at each layer is obtained, the audio synthesis is performed on the layer audio signals at the plurality of layers to obtain the audio signal.

In some embodiments, the bitstream includes a low-frequency bitstream and a high-frequency bitstream. Step 602 in FIG. 10 may be implemented by the following steps: decoding a low-frequency bitstream at each layer separately to obtain a low-frequency signal feature at each layer, and decoding a high-frequency bitstream at each layer separately to obtain a high-frequency signal feature at each layer. Correspondingly, step 603 in FIG. 10 may be implemented by the following steps. Step 6031: Perform feature reconstruction on the low-frequency signal feature at each layer separately to obtain a layer low-frequency subband signal at each layer, and perform feature reconstruction on the high-frequency signal feature at each layer separately to obtain a layer high-frequency subband signal at each layer. Step 6032: Use the layer low-frequency subband signal and the layer high-frequency subband signal as the layer audio signal at each layer. Correspondingly, step 604 in FIG. 10 may be implemented by the following steps. Step 6041: Add layer low-frequency subband signals at the plurality of layers to obtain a low-frequency subband signal, and add layer high-frequency subband signals at the plurality of layers to obtain a high-frequency subband signal. Step 6042: Synthesize the low-frequency subband signal and the high-frequency subband signal to obtain the audio signal.

In some embodiments, step 6042 may be implemented by the following steps. Step 60421: Upsample the low-frequency subband signal to obtain a low-frequency filtered signal. Step 60422: Upsample the high-frequency subband signal to obtain a high-frequency filtered signal. Step 60423: Perform filtering synthesis on the low-frequency filtered signal and the high-frequency filtered signal to obtain the audio signal. In step 60423, synthesis processing may be performed by a QMF synthesis filter to obtain the audio signal.

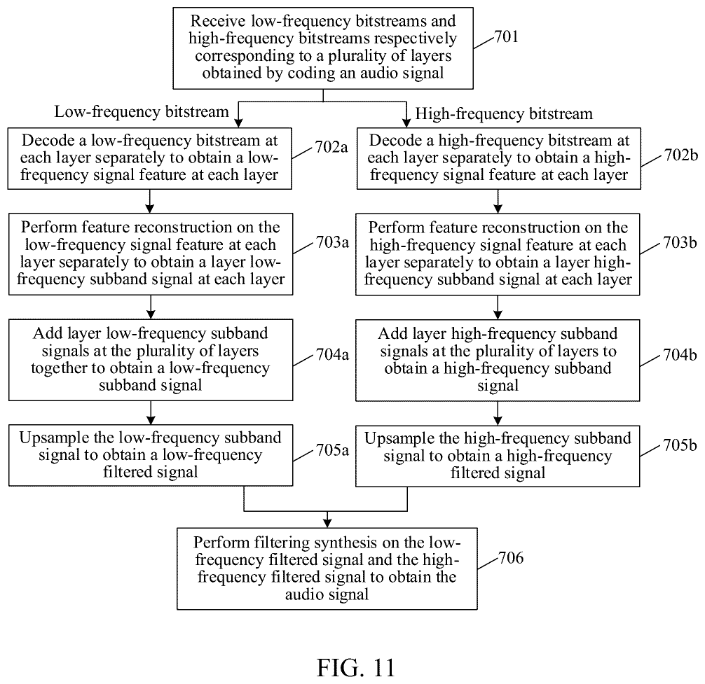

Based on this, when the bitstream includes the low-frequency bitstream and the high-frequency bitstream, with reference to FIG. 11. FIG. 11 is a schematic flowchart of an audio decoding method according to an embodiment of the present disclosure. The audio decoding method provided in this embodiment of the present disclosure includes: Step 701: Receive low-frequency bitstreams and high-frequency bitstreams respectively corresponding to a plurality of layers obtained by coding an audio signal. Step 702a: Decode a low-frequency bitstream at each layer separately to obtain a low-frequency signal feature at each layer. Step 702b: Decode a high-frequency bitstream at each layer separately to obtain a high-frequency signal feature at each layer. Step 703a: Perform feature reconstruction on the low-frequency signal feature at each layer separately to obtain a layer low-frequency subband signal at each layer. Step 703b: Perform feature reconstruction on the high-frequency signal feature at each layer separately to obtain a layer high-frequency subband signal at each layer. Step 704a: Add layer low-frequency subband signals at the plurality of layers to obtain a low-frequency subband signal. Step 704b: Add layer high-frequency subband signals at the plurality of layers to obtain a high-frequency subband signal. Step 705a: Upsample the low-frequency subband signal to obtain a low-frequency filtered signal. Step 705b: Upsample the high-frequency subband signal to obtain a high-frequency filtered signal. Step 706: Perform filtering synthesis on the low-frequency filtered signal and the high-frequency filtered signal to obtain the audio signal.

For feature reconstruction processes of the high-frequency signal feature and the low-frequency signal feature, refer to the feature reconstruction process of the signal feature in step 603. To be specific, for the high-frequency signal feature at each layer, the following processing is performed separately: Performing first convolution processing on the high-frequency signal feature to obtain a high-frequency convolution feature at the layer; upsampling the high-frequency convolution feature to obtain a high-frequency upsampled feature at the layer; performing pooling processing on the high-frequency upsampled feature to obtain a high-frequency pooled feature at the layer; and performing second convolution processing on the high-frequency pooled feature to obtain a high-frequency layer audio signal at the layer. For the low-frequency signal feature at each layer, the following processing is performed separately: Performing first convolution processing on the low-frequency signal feature to obtain a low-frequency convolution feature at the layer; upsampling the low-frequency convolution feature to obtain a low-frequency upsampled feature at the layer; performing pooling processing on the low-frequency upsampled feature to obtain a low-frequency pooled feature at the layer; and performing second convolution processing on the low-frequency pooled feature to obtain a low-frequency layer audio signal at the layer.

The embodiments of the present disclosure are used for decoding bitstreams at a plurality of layers separately to obtain a signal feature at each layer, performing feature reconstruction on the signal feature at each layer to obtain a layer audio signal at each layer, and performing audio synthesis on layer audio signals at the plurality of layers to obtain the audio signal. Because a data dimension of the signal feature in the bitstreams is less than a data dimension of the audio signal, compared with a data dimension of a bitstream obtained by directly coding an original audio signal in the related art, the data dimension is less. This reduces a data dimension of data processed during an audio decoding process and improves decoding efficiency of the audio signal.

Exemplary application of this embodiment of the present disclosure in an actual application scenario is described below.

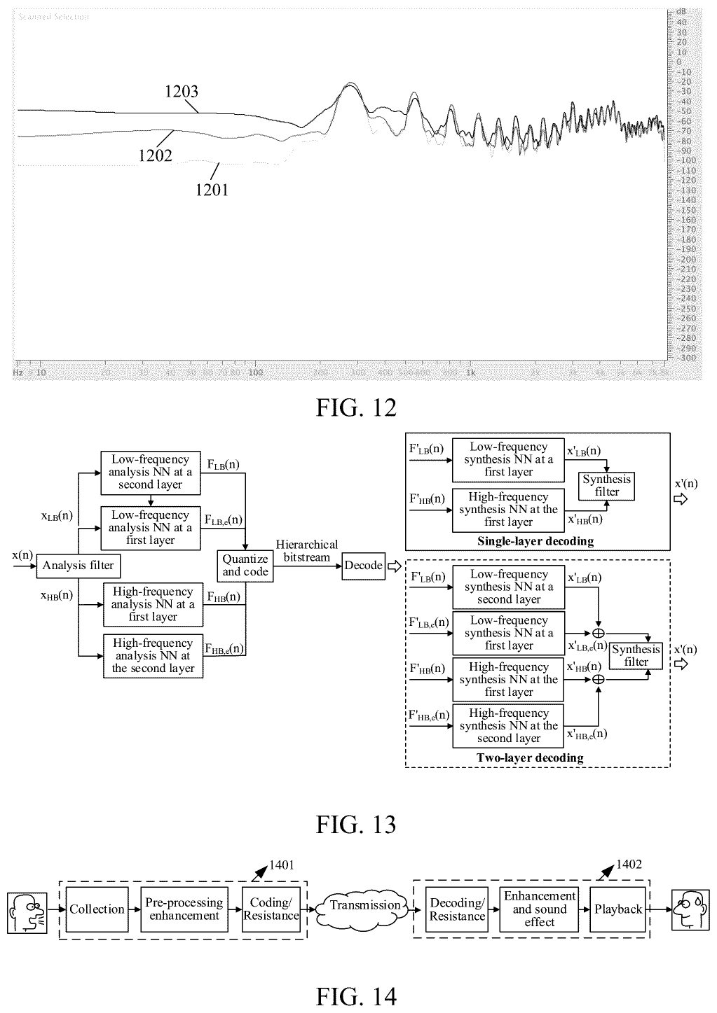

An audio coding and decoding technology uses few network bandwidth resources to transmit as much voice information as possible. A compression rate of an audio codec may reach more than ten times, to be specific, original 10 MB of voice data only needs 1 MB to be transmitted after compression by the codec. This greatly reduces bandwidth resources required to transmit information. In a communication system, to ensure smooth communication, standard voice codec protocols are deployed in the industry, such as standards from international and domestic standards organizations that are the International Telecommunication Union-Telecommunication Standardization Sector (ITU-T for ITU Telecommunication Standardization Sector), the 3^{rd} Generation Partnership Project (3GPP), the International Internet Engineering Task Force (IETF), and the Audio Video Coding Standard (AVS), the China Communications Standards Association (CCSA), and standards such as G.711, G.722, AMR series, EVS, OPUS. FIG. 12 is a schematic diagram of spectrum comparison with different bit rates to demonstrate a relationship between a compression bit rate and quality. A curve 1201 is a spectrum curve of an original voice, that is, a signal without compression. A curve 1202 is a spectrum curve of an OPUS encoder at 20 kbps bit rate. A curve 1203 is a spectrum curve of an OPUS encoder at 6 kbps bit rate. It can be learned from FIG. 12 that as a bit rate increases, a compressed signal is closer to an original signal.

Traditional audio coding may be divided into two types: time domain coding and frequency domain coding, both the time domain coding and the frequency domain coding are compression methods based on signal processing. (1) Time domain coding, such as waveform speech coding: It refers to coding a waveform of a voice signal directly. An advantage of the coding manner is that quality of a coded voice is high, but coding efficiency is low. Specifically, a voice signal may use parametric coding, and an encoder side needs to extract a corresponding parameter of the voice signal to be transmitted. However, an advantage of the parametric coding is that coding efficiency is extremely high, but quality of a restored voice is extremely low. (2) Frequency domain coding: It refers to transforming an audio signal into a frequency domain, extracting a frequency domain coefficient, and then coding the frequency domain coefficient. However, coding efficiency of the frequency domain coding is not good. In this way, the compression methods based on signal processing cannot improve coding efficiency while coding quality is ensured.

Based on this, embodiments of the present disclosure provide an audio coding method an audio decoding method, to ensure coding quality while coding efficiency is improved. In this embodiment of the present disclosure, the degree of freedom of different coding methods may be selected according to coding content and network bandwidth conditions, even in a low bit rate range; and coding efficiency may be improved while complexity and coding quality are acceptable. FIG. 13 is a schematic flowchart of audio coding and audio decoding according to an embodiment of the present disclosure. An example in which a quantity of layers is two is used here (where an iterative operation at a third layer or a higher layer is not limited in the present disclosure), an audio coding method provided in this embodiment of the present disclosure includes:
(1): Perform subband decomposition on an audio signal to obtain a low-frequency subband signal and a high-frequency subband signal. In an actual implementation, the audio signal may be sampled according to first sampling frequency to obtain a sampled signal, and then subband decomposition may be performed on the sampled signal to obtain a subband signal with frequency lower than the first sampling frequency, including the low-frequency subband signal and the high-frequency subband signal. For example, for an audio signal x(n) of an n^{th} frame, an analysis filter (such as a QMF filter) is configured to decompose the audio signal into a low-frequency subband signal x_{LB}(n) and a high-frequency subband signal x_{HB}(n).
(2): Analyze the low-frequency subband signal based on a low-frequency analysis neural network at a first layer to obtain a low-frequency signal feature at the first layer. For example, for a low-frequency subband signal x_{LB}(n), the low-frequency analysis neural network at the first layer is called to obtain a low-dimensional low-frequency signal feature F_{LB}(n) at the first layer. A dimension of the signal feature is less than a dimension of the low-frequency subband signal (to reduce an amount of data). The neural network includes but is not limited to Dilated CNN, Autoencoder, Full-connection, LSTM, CNN+LSTM, and the like.
(3): Analyze the high-frequency subband signal based on a high-frequency analysis neural network at a first layer to obtain a high-frequency signal feature at the first layer. For example, for a high-frequency subband signal x_{HB}(n), the high-frequency analysis neural network at the first layer is called to obtain a low-dimensional high-frequency signal feature F_{HB}(n) at the first layer.
(4): Analyze the low-frequency subband signal and the low-frequency signal feature at the first layer based on a low-frequency analysis neural network at a second layer to obtain a low-frequency signal feature at the second layer (that is, a low-frequency residual signal feature at the second layer). For example, x_{LB}(n) and F_{LB}(n) are combined to obtain a low-dimensional low-frequency signal feature F_{LB,e}(n) at the second layer by calling the low-frequency analysis neural network at the second layer.
(5): Analyze the high-frequency subband signal and the high-frequency signal feature at the first layer based on a high-frequency analysis neural network at a second layer to obtain a high-frequency signal feature at the second layer (that is, a high-frequency residual signal feature at the second layer). For example, x_{HB}(n) and F_{HB}(n) are combined to obtain a low-dimensional high-frequency signal feature F_{HB,e}(n) at the second layer by calling the high-frequency analysis neural network at the second layer.
(6): Quantize and code the signal features at the two layers (including the low-frequency signal feature at the first layer, the high-frequency signal feature at the first layer, the low-frequency signal feature at the second layer, and the high-frequency signal feature at the second layer) by using a quantization and coding part to obtain a bitstream of the audio signal at each layer; and configure a corresponding transmission priority for the bitstream at each layer. For example, at the first layer, a higher priority is configured for transmission, at the second layer, a lower priority is configured for transmission, and so on.

In an exemplary embodiment, a decoder side may only receive a bitstream at one layer, as shown in FIG. 13, and a manner of “single-layer decoding” may be used for decoding. Based on this, an audio decoding method provided in this embodiment of the present disclosure includes: (1): Decode the received bitstream at one layer to obtain a low-frequency signal feature and a high-frequency signal feature at the layer. (2): Analyze the low-frequency signal feature based on a low-frequency synthesis neural network at the first layer to obtain a low-frequency subband signal estimate. For example, based on a quantized value F′_{LB}(n) of the low-frequency signal feature, the low-frequency synthesis neural network at the first layer is called to generate the low-frequency subband signal estimate x′_{LB}(n). (3): Analyze the high-frequency signal feature based on a high-frequency synthesis neural network at the first layer to obtain a high-frequency subband signal estimate. For example, based on a quantized value F′_{HB}(n) of the high-frequency signal feature, the high-frequency synthesis neural network at the first layer is called to generate the high-frequency subband signal estimate x′_{HB}(n). (4): Perform synthesis filtering by a synthesis filter to obtain a finally reconstructed audio signal x′(n) at original sampling frequency based on the low-frequency subband signal estimate x′_{LB}(n) and the high-frequency subband signal estimate x′_{HB}(n), to complete a decoding process.

In an exemplary embodiment, the decoder side may both receive bitstreams at two layers, as shown in FIG. 13, and a manner of “two-layer decoding” may be used for decoding. Based on this, an audio decoding method provided in this embodiment of the present disclosure includes:
(1): Decode the received bitstream at each layer to obtain a low-frequency signal feature and a high-frequency signal feature at each layer.
(2): Analyze the low-frequency signal feature at the first layer based on the low-frequency synthesis neural network at the first layer to obtain a low-frequency subband signal estimate at the first layer. For example, based on a quantized value F′_{LB}(n) of the low-frequency signal feature at the first layer, the low-frequency synthesis neural network at the first layer is called to generate a low-frequency subband signal estimate x′_{LB}(n) at the first layer.
(3): Analyze the high-frequency signal feature at the first layer based on a high-frequency synthesis neural network at the first layer to obtain a high-frequency subband signal estimate at the first layer. For example, based on a quantized value F′_{HB}(n) of the high-frequency signal feature at the first layer, the high-frequency synthesis neural network at the first layer is called to generate a high-frequency subband signal estimate x′_{HB}(n) at the first layer.
(4): Analyze the low-frequency signal feature at the second layer based on a low-frequency synthesis neural network at the second layer to obtain a low-frequency subband residual signal estimate at the second layer. For example, based on a quantized value F′_{LB,e}(n) of the low-frequency signal feature at the second layer, the low-frequency synthesis neural network at the second layer is called to generate the low-frequency subband residual signal estimate x′_{LB,e}(n) at the second layer.
(5): Analyze the high-frequency signal feature at the second layer based on a high-frequency synthesis neural network at the second layer to obtain a high-frequency subband residual signal estimate at the second layer. For example, based on a quantized value F′_{HB,e}(n) of the high-frequency signal feature at the second layer, the high-frequency synthesis neural network at the second layer is called to generate a high-frequency subband residual signal estimate x′_{HB,e}(n).
(6): Sum the low-frequency subband signal estimate at the first layer and the low-frequency subband residual signal estimate by using a low-frequency part to obtain a low-frequency subband signal estimate. For example, x′_{LB}(n) and x′_{LB,e}(n) are summed to obtain the low-frequency subband signal estimate.
(7): Sum the high-frequency subband signal estimate at the first layer and the high-frequency subband residual signal estimate by using a high-frequency part to obtain a high-frequency subband signal estimate. For example, x′_{HB}(n) and x′_{HB,e}(n) are summed to obtain the high-frequency subband signal estimate with high quality.
(8): Perform synthesis filtering by a synthesis filter to obtain a finally reconstructed audio signal x′(n) at original sampling frequency based on the low-frequency subband signal estimate and the high-frequency subband signal estimate, to complete a decoding process.

This embodiment of the present disclosure may be used in various audio scenarios, such as remote voice communication. An example of remote voice communication is used. FIG. 14 is a schematic diagram of a voice communication link according to an embodiment of the present disclosure. An example of a conference system based on the Voice over Internet Protocol (VoIP) is used, an audio coding and decoding technology in this embodiment of the present disclosure is deployed in a coding and decoding part to achieve a basic function of voice compression. An encoder is deployed on an uplink client 1401, and a decoder is deployed on a downlink client 1402. Voice is collected by the uplink client, and pre-processing enhancement, coding, and another processing are performed, and a coded bitstream is transmitted to the downlink client 1402 via a network. The downlink client 1402 performs decoding, enhancement, and another processing to play the decoded voice on the downlink client 1402.

Forward compatibility (that is, a new encoder is compatible with an existing encoder) is considered, a transcoder needs to be deployed in background (that is, a server) of a system to solve a problem of interworking between the new encoder and the existing encoder. For example, if a transmit end (an uplink client) is a new NN encoder, a receive end (a downlink client) is a decoder (such as a G.722 decoder) of a public switched telephone network (PSTN). Therefore, after receiving the bitstream sent by the transmit end, the server first needs to execute the NN decoder to generate a voice signal, and then calls a G.722 encoder to generate a specific bitstream, so that the receive end can decode the bitstream correctly. A similar transcoding scenario is not described again.

Before introducing an audio coding method and an audio decoding method provided in this embodiment of the present disclosure in detail below, a QMF filterbank and a dilated convolutional network are introduced first.

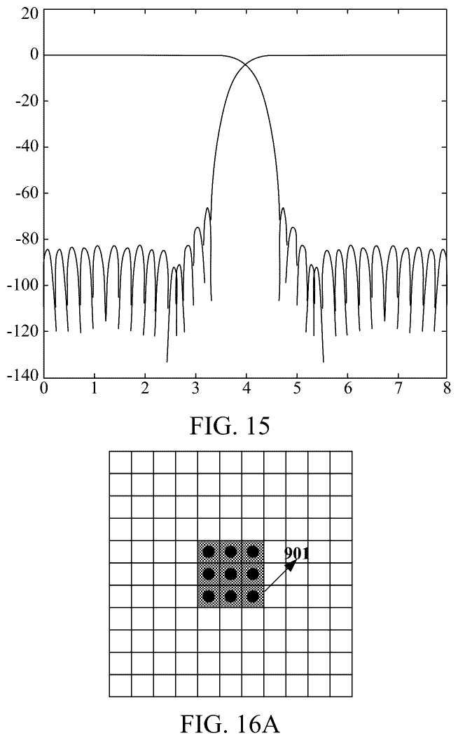

The QMF filterbank is a filter pair including analysis-synthesis. For the QMF analysis filter, an inputted signal with a sampling rate of Fs may be decomposed into two signals with a sampling rate of Fs/2, representing a QMF low-pass signal and a QMF high-pass signal respectively. A spectral response of a low-pass part (H_Low(z)) and a high-pass part (H_High(z)) of the QMF filter is shown in FIG. 15. Based on relevant theoretical knowledge of a QMF analysis filterbank, a correlation between coefficients of the foregoing low-pass filtering and high-pass filtering can be easily described, as shown in formula (1):

$${h}_{High} ( k ) = - {1}^{k} {h}_{Low} ( k ) \qquad ( 1 )$$

h_{Low}(k) represents a coefficient of the low-pass filtering and h_{High}(k) represents a coefficient of the high-pass filtering.

Similarly, according to QMF related theories, QMF analysis filterbanks H_Low(z) and H_High(z) may be used to describe a QMF synthesis filterbank, as shown in formula (2).

$${G}_{Low} ( z ) = {H}_{Low} ( z ) \qquad ( 2 )$$

$${G}_{High} ( z ) = ( - 1 ) * {H}_{High} ( z )$$

G_{Low}(z) represents a restored low-pass signal and G_{High}(z) represents a restored high-pass signal.

The low-pass signal and the high-pass signal restored at a decoder side are synthesized and processed by the QMF synthesis filterbank, and a reconstructed signal with the sampling rate of Fs corresponding to an inputted signal can be restored.

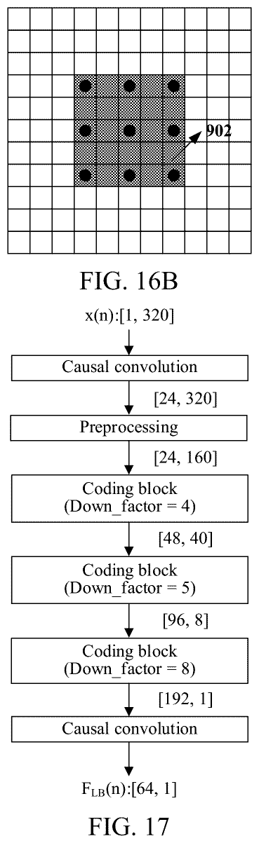

FIG. 16A is a schematic diagram of a common convolutional network according to an embodiment of the present disclosure. FIG. 16B is a schematic diagram of a dilated convolutional network according to an embodiment of the present disclosure. Compared with the common convolutional network, the dilated convolution network may increase a receptive field while a size of a feature map remains unchanged. In addition, the dilated convolution network may avoid errors caused by upsampling and downsampling. Although convolution kernel sizes shown in FIG. 16A and FIG. 16B are both 3×3, a receptive field 901 of the common convolution shown in FIG. 16A is only 3, while a receptive field 902 of the dilated convolution shown in FIG. 16B reaches 5. In other words, for a convolution kernel with a size 3×3, the receptive field of the common convolution shown in FIG. 16A is 3, and a dilation rate (where a quantity of points spaced in the convolution kernel) is 1; while the receptive field of the dilated convolution shown in FIG. 16B is 5, and a dilation rate is 2.

In addition, the convolution kernel may move on a plane similar to FIG. 16A or FIG. 16B. This relates to a concept of a stride rate (a step size). For example, each time the convolution kernel is strode by one grid, a corresponding stride rate is 1. In addition, there is also a concept of a quantity of convolution channels, that is, a quantity of parameters corresponding to a quantity of convolution kernels used for convolution analysis. Theoretically, a greater quantity of channels indicates more comprehensive signal analysis and higher accuracy. However, a greater quantity of channels also indicates higher complexity. For example, a tensor of 1×320 can use a 24-channel convolution operation, and output is a tensor of 24×320. A size of a dilated convolution kernel (for example, for a voice signal, the size of the convolution kernel may be set to 1×3), a dilation rate, a stride rate, and a quantity of channels may be defined according to actual application needs. This is not limited in this embodiment of the present disclosure.

An example of an audio signal with Fs=32000 Hz is used (where this embodiment of the present disclosure is also applicable to another sampling frequency scenario, including but not limited to 8000 Hz, 16000 Hz, 48000 Hz, and the like), in which a frame length is set to 20 ms, for Fs=32000 Hz, it is equivalent to each frame including 640 sample points.

Continue to refer to FIG. 13, the audio coding method and the audio decoding method provided in this embodiment of the present disclosure are described in detail respectively. The audio coding method provided in this embodiment of the present disclosure includes: Step 1: Generate an input signal.

640 sample points of an nth frame are recorded as x(n) herein.

Step 2: Decompose a QMF subband signal.

A QMF analysis filter (such as a two-channel QMF filter) is called for filtering processing herein, and a filtered signal is downsampled to obtain two subband signals, namely, a low-frequency subband signal x_{LB}(n) and a high-frequency subband signal x_{HB}(n). An effective bandwidth of the low-frequency subband signal x_{LB}(n) is 0 to 8 kHz, an effective bandwidth of the high-frequency subband signal x_{HB}(n) is 8 to 16 kHz, and a quantity of sample points of each frame is 320.

Step 3: Perform low-frequency analysis at a first layer.

An objective of calling a low-frequency analysis neural network at the first layer herein is to generate a lower-dimensional low-frequency signal feature F_{LB}(n) at the first layer based on the low-frequency subband signal x_{LB}(n). In this example, a data dimension of X_{LB}(n) is 320, and a data dimension of F_{LB}(n) is 64. As for an amount of data, it is obvious that after the low-frequency analysis neural network at the first layer, “dimensionality reduction” is achieved. This may be understood as data compression. For example, FIG. 17 is a schematic diagram of a structure of a low-frequency analysis neural network at a first layer according to an embodiment of the present disclosure. A processing flow of the low-frequency subband signal X_{LB}(n) includes:
(1): Call a 24-channel causal convolution to expand an input tensor (that is, X_{LB}(n)) into a tensor of 24×320.
(2): Preprocess the tensor of 24×320. In an exemplary embodiment, a pooling operation with a pooling factor of 2 may be performed, and an activation function may be ReLU to generate a tensor of 24×160.
(3) Cascade three coding blocks with different Down_factors. An example of a coding block with (Down_factor=4) is used, one or more dilated convolutions may be performed first. A size of each convolution kernel is 1×3, and a stride rate of each convolution kernel is 1. In addition, a dilation rate of the one or more dilated convolutions may be set as needed, such as 3. Certainly, different dilated convolutions being set with different dilation rates is not limited in this embodiment of the present disclosure. Then, the Down_factors of the three coding blocks are set to 4, 5, and 8 respectively. This is equivalent to setting pooling factors of different sizes to play a down-sampling effect. Finally, channel quantities of the three coding blocks are set to 48, 96, and 192 respectively. Therefore, after three cascaded coding blocks, the tensor of 24×160 is converted into a tensor of 48×40, a tensor of 96×8, and a tensor of 192×1 respectively.
(4) For the tensor of 192×1, after a causal convolution similar to preprocessing, a 64-dimensional feature vector is outputted, that is, the low-frequency signal feature F_{LB}(n) at the first layer.

Step 4: Perform high-frequency analysis at the first layer.

An objective of calling a high-frequency analysis neural network at the first layer herein is to generate a lower-dimensional high-frequency signal feature F_{HB}(n) at the first layer based on the high-frequency subband signal x_{HB}(n). In this example, a structure of the high-frequency analysis neural network at the first layer may be consistent with a structure of the low-frequency analysis neural network at the first layer, in other words, a data dimension of input (that is, x_{HB}(n)) is 320 dimensions, and a data dimension of output (that is, F_{HB}(n)) is 64 dimensions. It is considered that the high-frequency subband signal is less important than the low-frequency subband signal, an output dimension may be appropriately reduced. This can reduce complexity of the high-frequency analysis neural network at the first layer. This is not limited in this example.

Step 5: Perform low-frequency analysis at a second layer.

An objective of calling a low-frequency analysis neural network at the second layer herein is to obtain a lower-dimensional low-frequency signal feature F_{LB,e}(n) at the second layer based on the low-frequency subband signal x_{LB}(n) and the low-frequency signal feature F_{LB}(n) at the first layer. The low-frequency signal feature at the second layer reflects residual of a reconstructed audio signal at the decoder side of the output by the low-frequency analysis neural network at the first layer relative to an original audio signal. Therefore, at the decoder side, a residual signal of the low-frequency subband signal can be predicted according to F_{LB,e}(n), and a low-frequency subband signal estimate with higher precision can be obtained by summing the residual signal and a low-frequency subband signal estimate predicted by the output by the low-frequency analysis neural network at the first layer.

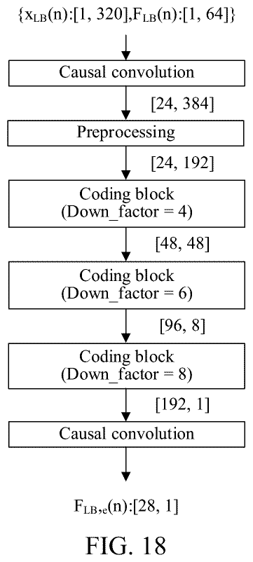

The low-frequency analysis neural network at the second layer adopts a similar structure to the low-frequency analysis neural network at the first layer. FIG. 18 is a schematic diagram of a structure of a low-frequency analysis neural network at a second layer according to an embodiment of the present disclosure. Main differences between the low-frequency analysis neural network at the second layer and the low-frequency analysis neural network at the first layer include: (1) In addition to the low-frequency subband signal x_{LB}(n), input by the low-frequency analysis neural network at the second layer also includes the output F_{LB}(n) by the low-frequency analysis neural network at the first layer, and two variables x_{LB}(n) and F_{LB}(n) may be spliced into a spliced feature with 384 dimensions. (2) It is considered that the low-frequency analysis at the second layer processes the residual signal, a dimension of the output F_{LB,e}(n) of the low-frequency analysis neural network at the second layer is set to 28.

Step 6: Perform high-frequency analysis at the second layer.

An objective of calling a high-frequency analysis neural network at the second layer herein is to obtain a lower-dimensional high-frequency signal feature F_{HB,e}(n) at the second layer based on the high-frequency subband signal x_{HB}(n) and the high-frequency signal feature F_{HB}(n) at the first layer. A structure of the high-frequency analysis neural network at the second layer may be the same as the structure of the low-frequency analysis neural network at the second layer, in other words, a data dimension of input (a spliced feature of x_{HB}(n) and F_{HB}(n)) is 384 dimensions, and a data dimension of output (F_{HB,e}(n)) is 28 dimensions.

Step 7: Quantize and code.

A signal feature outputted at the second layer is quantized by querying a preset quantization table, and a quantized result obtained by quantization is coded. A manner of scalar quantization (where each component is individually quantized) may be adopted for quantization, and a manner of entropy coding may be adopted for coding. In addition, a technical combination of vector quantization (where a plurality of adjacent components are combined into one vector for joint quantization) and entropy coding is not limited in this embodiment of the present disclosure.

In an actual implementation, the low-frequency signal feature F_{LB}(n) at the first layer is a feature with 64 dimensions, which may be coded by using 8 kbps. An average bit rate of quantizing one parameter per frame is 2.5 bit. The high-frequency signal feature F_{HB}(n) at the first layer is a feature with 64 dimensions, which may be coded by using 6 kbps. An average bit rate of quantizing one parameter per frame is 1.875 bit. Therefore, at the first layer, a total of 14 kbps may be used for coding.

In an actual implementation, the low-frequency signal feature F_{LB,e}(n) at the second layer is a feature with 28 dimensions, which may be coded by using 3.5 kbps. An average bit rate of quantizing one parameter per frame is 2.5 bit. The high-frequency signal feature F_{HB,e}(n) at the second layer is a feature with 28 dimensions, which may be coded by using 3.5 kbps. An average bit rate of quantizing one parameter per frame is 2.5 bit. Therefore, at the second layer, a total of 7 kbps may be used for coding.

Based on this, different feature vectors can be progressively coded by hierarchical coding. According to different application scenarios, bit rate distribution in other manners is not limited in this embodiment of the present disclosure. For example, third-layer or higher-layer coding may further be introduced iteratively. After quantization and coding, a bitstream may be generated. Different transmission policies may be used for bitstreams at different layers to ensure transmission with different priorities. For example, a forward error correction (FEC) mechanism may be used to improve quality of transmission by using redundant transmission. Redundancy multiples at different layers are different. For example, a redundancy multiple at the first layer may be set higher.

An example in which bitstreams at all layers are received by the decoder side and decoded accurately is used, the audio decoding method provided in this embodiment of the present disclosure includes:

Step 1: Decode.

Decoding here is an inverse process of coding. A received bitstream is parsed and a low-frequency signal feature estimate and a high-frequency signal feature estimate are obtained by querying a quantization table. For example, at a first layer, a quantized value F′_{LB}(n) of a signal feature with 64 dimensions of a low-frequency subband signal and a quantized value F′_{HB}(n) of a signal feature with 64 dimensions of a high-frequency subband signal are obtained. At a second layer, a quantized value F′_{LB,e}(n) of a signal feature with 28 dimensions of a low-frequency subband signal and a quantized value F′_{HB,e}(n) of a signal feature with 28 dimensions of a high-frequency subband signal are obtained.

Step 2: Perform low-frequency synthesis at the first layer.

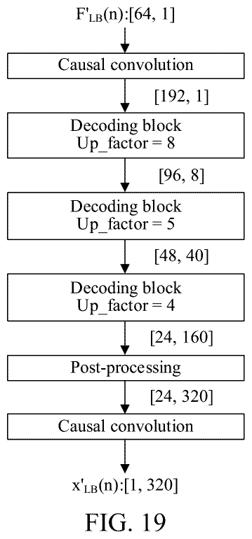

An objective of calling a low-frequency synthesis neural network at the first layer herein is to generate a low-frequency subband signal estimate x′_{LB}(n) at the first layer based on the quantized value F′_{LB}(n) of a low-frequency feature vector. For example, FIG. 19 is a schematic diagram of a model of a low-frequency synthesis neural network at a first layer according to an embodiment of the present disclosure. A processing flow of the low-frequency synthesis neural network at the first layer here is similar to that of the low-frequency analysis neural network at the first layer, such as a causal convolution. A post-processing structure of the low-frequency synthesis neural network at the first layer is similar to a preprocessing structure of the low-frequency analysis neural network at the first layer. A decoding block structure is symmetrical to a coding block structure. A coding block on a coding side first performs a dilated convolution and then performs pooling to complete down-sampling. A decoding block on a decoding side first performs pooling to complete up-sampling and then performs the dilated convolution.

Step 3: Perform high-frequency synthesis at the first layer.

A structure of a high-frequency synthesis neural network at the first layer here is the same as the structure of the low-frequency synthesis neural network at the first layer. A high-frequency subband signal estimate x′_{HB}(n) at the first layer can be obtained based on the quantized value F′_{HB}(n) of the low-frequency signal feature at the first layer.

Step 4: Perform low-frequency synthesis at the second layer.

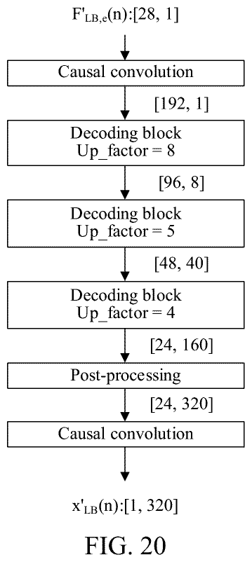

An objective of calling a low-frequency synthesis neural network at the second layer herein is to generate a low-frequency subband residual signal estimate x′_{LB,e}(n) based on the quantized value F′_{LB,e}(n) of the low-frequency signal feature at the second layer. FIG. 20 is a schematic diagram of a structure of a low-frequency synthesis neural network at a second layer according to an embodiment of the present disclosure. The structure of the low-frequency synthesis neural network at the second layer is similar to the structure of the low-frequency synthesis neural network at the first layer. A difference is that a data dimension of input is 28 dimensions.

Step 5: Perform high-frequency synthesis at the second layer.

A structure of a high-frequency synthesis neural network at the second layer here is the same as the structure of the low-frequency synthesis neural network at the second layer. A high-frequency subband residual signal estimate x′ _{HB,e}(n) can be obtained based on the quantized value F′_{HB,e}(n) of the low-frequency signal feature at the second layer.

Step 6: Perform synthesis filtering.

Based on the previous steps, the decoder side obtains the low-frequency subband signal estimate x′_{LB}(n) and the high-frequency subband signal x′_{HB}(n), as well as the low-frequency subband residual signal estimate x′_{LB,e}(n) and the high-frequency subband residual signal estimate x′_{HB,e}(n). x′_{LB}(n) and x′_{LB,e}(n) are summed to generate a low-frequency subband signal estimate with high precision. x′_{HB}(n) and x′_{HB,e}(n) are summed to generate a high-frequency subband signal estimate with high precision. Finally, the low-frequency subband signal estimate and the high-frequency subband signal estimate are upsampled, and a QMF synthesis filter is called to synthesize and filter an upsampled result to generate a reconstructed audio signal x′(n) with 640 points.

In this embodiment of the present disclosure, relevant neural networks at the encoder side and the decoder side may be jointly trained by collecting data to obtain optimal parameters, so that a trained network model is put into use. In this embodiment of the present disclosure, only one embodiment with specific network input, a specific network structure, and specific network output is disclosed. An engineer in relevant fields may modify the foregoing configuration as needed.

By using the embodiments of the present disclosure, a low bit rate audio coding and decoding scheme based on signal processing and a deep learning network can be completed. Through an organic combination of signal decomposition and a related signal processing technology with a deep neural network, coding efficiency is significantly improved compared to related arts, and coding quality is also improved while complexity is acceptable. According to different coding content and bandwidths, the encoder side selects different hierarchical transmission policies for bitstream transmission. The decoder side receives a bitstream at a low layer and outputs an audio signal with acceptable quality. If the decoder side also receives another bitstream at a high layer, the decoder side may output an audio signal with high quality.

In the embodiments of the present disclosure, data related to user information (such as an audio signal sent by a user) and the like is involved. When the embodiments of the present disclosure are applied to products or technologies, user permission or consent needs to be obtained, and collection, use, and processing of related data need to comply with relevant laws, regulations, and standards of relevant countries and regions.

The following continues to describe an exemplary structure in which an audio coding apparatus 553 provided in this embodiment of the present disclosure is implemented as a software module. In some embodiments, as shown in FIG. 2, the software module stored in the audio coding apparatus 553 of a memory 550 may include:

a first feature extraction module 5531, configured to perform feature extraction on an audio signal at a first layer to obtain a signal feature at the first layer; a second feature extraction module 5532, configured to splice, for an i^{th} layer among N layers, the audio signal and a signal feature at an (i-1)^{th} layer to obtain a spliced feature, and perform feature extraction on the spliced feature at the i^{th} layer to obtain a signal feature at the i^{th} layer, N and i being integers greater than 1, and i being less than or equal to N; a traversing module 5533, configured to traverse i^{th} layers of the N layers to obtain a signal feature at each layer among the N layers, and a data dimension of the signal feature being less than a data dimension of the audio signal; and a coding module 5534, configured to code the signal feature at the first layer and the signal feature at each layer among the N layers separately to obtain a bitstream of the audio signal at each layer.

In some embodiments, the first feature extraction module 5531 is further configured to: perform subband decomposition on the audio signal to obtain a low-frequency subband signal and a high-frequency subband signal of the audio signal; perform feature extraction on the low-frequency subband signal at the first layer to obtain a low-frequency signal feature at the first layer, and perform feature extraction on the high-frequency subband signal at the first layer to obtain a high-frequency signal feature at the first layer; and use the low-frequency signal feature and the high-frequency signal feature as the signal feature at the first layer.

In some embodiments, the first feature extraction module 5531 is further configured to: sample the audio signal according to first sampling frequency to obtain a sampled signal; perform low-pass filtering on the sampled signal to obtain a low-pass filtered signal, and downsample the low-pass filtered signal to obtain the low-frequency subband signal at second sampling frequency; and perform high-pass filtering on the sampled signal to obtain a high-pass filtered signal, and downsample the high-pass filtered signal to obtain the high-frequency subband signal at the second sampling frequency. The second sampling frequency is less than the first sampling frequency.

In some embodiments, the second feature extraction module 5532 is further configured to: splice the low-frequency subband signal of the audio signal and a low-frequency signal feature at the (i-1)^{th} layer to obtain a first spliced feature, and perform feature extraction on the first spliced feature at the i^{th} layer to obtain a low-frequency signal feature at the i^{th} layer; splice the high-frequency subband signal of the audio signal and a high-frequency signal feature at the (i-1)^{th} layer to obtain a second spliced feature, and perform feature extraction on the second spliced feature at the i^{th} layer to obtain a high-frequency signal feature at the i^{th} layer; and use the low-frequency signal feature at the i^{th} layer and the high-frequency signal feature at the i^{th} layer as the signal feature at the i^{th} layer.

In some embodiments, the first feature extraction module 5531 is further configured to: perform first convolution processing on the audio signal to obtain a convolution feature at the first layer; perform first pooling processing on the convolution feature to obtain a pooled feature at the first layer; perform first downsampling on the pooled feature to obtain a downsampled feature at the first layer; and perform second convolution processing on the downsampled feature to obtain the signal feature at the first layer.

In some embodiments, the first downsampling is performed by M cascaded coding layers, and the first feature extraction module 5531 is further configured to: perform first downsampling on the pooled feature by a first coding layer among the M cascaded coding layers to obtain a downsampled result at the first coding layer; perform the first downsampling on a downsampled result at a (j-1)^{th} coding layer by a j^{th} coding layer among the M cascaded coding layers to obtain a downsampled result at the j^{th} coding layer, M and j being integers greater than 1, and j being less than or equal to M; and traverse j to obtain a downsampled result at an M^{th} coding layer, and use the downsampled result at the M^{th} coding layer as the downsampled feature at the first layer.

In some embodiments, the second feature extraction module 5532 is further configured to: perform third convolution processing on the spliced feature to obtain a convolution feature at the i^{th} layer; perform second pooling processing on the convolution feature to obtain a pooled feature at the i^{th} layer; perform second downsampling on the pooled feature to obtain a downsampled feature at the i^{th} layer; and perform fourth convolution processing on the downsampled feature to obtain the signal feature at the i^{th} layer.

In some embodiments, the coding module 5534 is further configured to: quantize the signal feature at the first layer and the signal feature at each layer among the N layers separately to obtain a quantized result of a signal feature at each layer; and perform entropy coding on the quantized result of the signal feature at each layer to obtain the bitstream of the audio signal at each layer.

In some embodiments, the signal feature includes a low-frequency signal feature and a high-frequency signal feature, and the coding module 5534 is further configured to: code a low-frequency signal feature at the first layer and a low-frequency signal feature at each layer among the N layers separately to obtain a low-frequency bitstream of the audio signal at each layer; code a high-frequency signal feature at the first layer and a high-frequency signal feature at each layer among the N layers separately to obtain a high-frequency bitstream of the audio signal at each layer; and use the low-frequency bitstream and the high-frequency bitstream of the audio signal at each layer as a bitstream of the audio signal at a corresponding layer.

In some embodiments, the signal feature includes a low-frequency signal feature and a high-frequency signal feature, and the coding module 5534 is further configured to: code a low-frequency signal feature at the first layer according to a first coding bit rate to obtain a first bitstream at the first layer, and code a high-frequency signal feature at the first layer according to a second coding bit rate to obtain a second bitstream at the first layer; and perform the following processing separately for the signal feature at each layer among the N layers: coding the signal feature at each layer separately according to a third coding bit rate at each layer to obtain a second bitstream at each layer; and using the second bitstream at the first layer and the second bitstream at each layer among the N layers as the bitstream of the audio signal at each layer. The first coding bit rate is greater than the second coding bit rate, the second coding bit rate is greater than the third coding bit rate of any layer among the N layers, and a coding bit rate of the layer is positively correlated with a decoding quality indicator of a bitstream of a corresponding layer.

In some embodiments, the coding module 5534 is further configured to perform the following processing separately for each layer: configuring a corresponding layer transmission priority for the bitstream of the audio signal at the layer. The layer transmission priority is negatively correlated with a layer level, and the layer transmission priority is positively correlated with a decoding quality indicator of a bitstream of a corresponding layer.

In some embodiments, the signal feature includes a low-frequency signal feature and a high-frequency signal feature, and the bitstream of the audio signal at each layer includes: a low-frequency bitstream obtained by coding based on the low-frequency signal feature and a high-frequency bitstream obtained by coding based on the high-frequency signal feature. The coding module 5534 is further configured to perform the following processing separately for each layer: configuring a first transmission priority for the low-frequency bitstream at the layer, and configuring a second transmission priority for the high-frequency bitstream at the layer. The first transmission priority is higher than the second transmission priority, the second transmission priority at the (i-1)^{th} layer is lower than the first transmission priority at the i^{th} layer, and a transmission priority of the bitstream is positively correlated with a decoding quality indicator of a corresponding bitstream.

Hierarchical coding of the audio signal can be implemented by using the embodiments of the present disclosure. First, the feature extraction is performed on the audio signal at the first layer to obtain the signal feature at the first layer. Then, for the i^{th} (where i is an integer greater than 1, and i is less than or equal to N) layer among the N (where N is an integer greater than 1) layers, the audio signal and the signal feature at the (i-1)^{th} layer are spliced to obtain the spliced feature, and the feature extraction is performed on the spliced feature at the i^{th} layer to obtain the signal feature at the i^{th} layer. Next, i is traversed to obtain the signal feature at each layer among the N layers. Finally, the signal feature at the first layer and the signal feature at each layer among the N layers are coded separately to obtain the bitstream of the audio signal at each layer.

First, a data dimension of the extracted signal feature is less than a data dimension of the audio signal. In this way, a data dimension of data processed in an audio coding process is reduced, and coding efficiency of the audio signal is improved.

Second, when a signal feature of the audio signal is extracted hierarchically, output at each layer is used as input at the next layer, so that each layer is enabled to combine a signal feature extracted from the previous layer to perform more accurate feature extraction on the audio signal. As a quantity of layers increases, an information loss of the audio signal during a feature extraction process can be minimized. In this way, audio signal information included in a plurality of bitstreams obtained by coding the signal feature extracted in this manner is close to an original audio signal, so that an information loss of the audio signal during a coding process is reduced, and coding quality of audio coding is ensured.

The following describes an audio decoding apparatus provided in an embodiment of the present disclosure. The audio decoding apparatus provided in the embodiment of the present disclosure includes: a receiving module, configured to receive bitstreams respectively corresponding to a plurality of layers obtained by coding an audio signal; a decoding module, configured to decode a bitstream at each layer separately to obtain a signal feature at each layer, and a data dimension of the signal feature being less than a data dimension of the audio signal; a feature reconstruction module, configured to perform feature reconstruction on the signal feature at each layer separately to obtain a layer audio signal at each layer; and an audio synthesis module, configured to perform audio synthesis on layer audio signals at the plurality of layers to obtain the audio signal.

In some embodiments, the bitstream includes a low-frequency bitstream and a high-frequency bitstream, and the decoding module is further configured to: decode a low-frequency bitstream at each layer separately to obtain a low-frequency signal feature at each layer, and decode a high-frequency bitstream at each layer separately to obtain a high-frequency signal feature at each layer. Correspondingly, the feature reconstruction module is further configured to: perform feature reconstruction on the low-frequency signal feature at each layer separately to obtain a layer low-frequency subband signal at each layer, and perform feature reconstruction on the high-frequency signal feature at each layer separately to obtain a layer high-frequency subband signal at each layer; and use the layer low-frequency subband signal and the layer high-frequency subband signal as the layer audio signal at each layer. Correspondingly, the audio synthesis module is further configured to: add layer low-frequency subband signals at the plurality of layers to obtain a low-frequency subband signal, and add layer high-frequency subband signals at the plurality of layers to obtain a high-frequency subband signal; and synthesize the low-frequency subband signal and the high-frequency subband signal to obtain the audio signal.

In some embodiments, the audio synthesis module is further configured to: upsample the low-frequency subband signal to obtain a low-frequency filtered signal; upsample the high-frequency subband signal to obtain a high-frequency filtered signal; and perform filtering synthesis on the low-frequency filtered signal and the high-frequency filtered signal to obtain the audio signal.

In some embodiments, the feature reconstruction module is further configured to perform the following processing separately for the signal feature at each layer: perform first convolution processing on the signal feature to obtain a convolution feature at the layer; upsample the convolution feature to obtain an upsampled feature at the layer; perform pooling processing on the upsampled feature to obtain a pooled feature at the layer; and perform second convolution processing on the pooled feature to obtain the layer audio signal at the layer.

In some embodiments, the upsampling is performed by L cascaded decoding layers, and the feature reconstruction module is further configured to: upsample the pooled feature by a first decoding layer among the L cascaded decoding layers to obtain an upsampled result at the first decoding layer; upsample a first upsampled result at a (k-1)^{th} decoding layer by a k^{th} decoding layer among the L cascaded decoding layers to obtain an upsampled result at the k^{th} decoding layer, L and k being integers greater than 1, and k being less than or equal to L; and traverse k to obtain an upsampled result of an L^{th} decoding layer, and use the upsampled result of the L^{th} decoding layer as the upsampled feature at the layer.

In some embodiments, the decoding module is further configured to perform the following processing separately for each layer: performing entropy decoding on the bitstream at the layer to obtain a quantized value of the bitstream; and performing inverse quantization processing on the quantized value of the bitstream to obtain the signal feature at the layer.

The embodiments of the present disclosure are used for decoding bitstreams at a plurality of layers separately to obtain a signal feature at each layer, performing feature reconstruction on the signal feature at each layer to obtain a layer audio signal at each layer, and performing audio synthesis on layer audio signals at the plurality of layers to obtain the audio signal. Because a data dimension of the signal feature is less than a data dimension of the audio signal, a data dimension of data processed is reduced during an audio decoding process, and decoding efficiency of the audio signal is improved.

An embodiment of the present disclosure further provides a computer program product or computer program. The computer program product or computer program includes computer instructions stored in a computer-readable storage medium. A processor of a computer device reads the computer instructions from the computer-readable storage medium, and the processor executes the computer instructions, so that the computer device performs the method provided in the embodiments of the present disclosure.

An embodiment of the present disclosure further provides a computer-readable storage medium having executable instructions stored thereon. The executable instructions, when executed by a processor, causes the processor to perform the method provided in the embodiments of the present disclosure.

Embodiments of the present disclosure have the following beneficial effects. For example, a signal feature at each layer is obtained by coding an audio signal hierarchically. Because a data dimension of the signal feature at each layer is less than a data dimension of the audio signal, a data dimension of data processed in an audio coding process is reduced and coding efficiency of the audio signal is improved. When a signal feature of the audio signal is extracted hierarchically, output at each layer is used as input at the next layer, so that each level is enabled to combine a signal feature extracted from the previous layer to perform more accurate feature extraction on the audio signal. As a quantity of layers increases, an information loss of the audio signal during a feature extraction process can be minimized. In this way, audio signal information included in a plurality of bitstreams obtained by coding the signal feature extracted in this manner is close to an original audio signal, so that an information loss of the audio signal during a coding process is reduced, and coding quality of audio coding is ensured.

In some embodiments, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disk, or a CD-ROM, and may also be a plurality of devices including one of the foregoing memories or any combination thereof.

In some embodiments, the executable instructions may be written in the form of program, software, software module, script, or code in any form of programming language (including compilation or interpretation language, or declarative or procedural language), and the executable instructions may be deployed in any form, including being deployed as an independent program or being deployed as a module, component, subroutine, or other units suitable for use in a computing environment.

As an example, the executable instructions may, but not necessarily, correspond to a file in a file system, and may be stored as a part of the file that stores other programs or data, for example, stored in one or more scripts in a Hyper Text Markup Language (HTML) document, stored in a single file dedicated to the program under discussion, or stored in a plurality of collaborative files (for example, a file that stores one or more modules, subroutines, or code parts).

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

As an example, the executable instructions may be deployed to execute on one computing device or on a plurality of computing devices located in one location, alternatively, on a plurality of computing devices distributed in a plurality of locations and interconnected through communication networks.

The foregoing is only an example of the embodiments of the present disclosure and is not intended to limit the scope of protection of the present disclosure. Any modification, equivalent replacement, and improvement within the spirit and scope of the present disclosure are included in the scope of protection of the present disclosure.

What is claimed is:

1. An audio coding method, performed by an electronic device, the method comprising:
performing feature extraction on an audio signal at a first layer to obtain a signal feature at the first layer;
splicing, for an i^{th} layer among N layers, the audio signal and a signal feature at an (i-1)^{th} layer to obtain a spliced feature, and performing feature extraction on the spliced feature at the i^{th} layer to obtain a signal feature at the i^{th} layer, N and i being integers greater than 1, and i being less than or equal to N;
traversing i^{th} layers of the N layers to obtain a signal feature at each layer among the N layers, and a data dimension of the signal feature being less than a data dimension of the audio signal; and
coding the signal feature at the first layer and the signal feature at each layer among the N layers separately to obtain a bitstream of the audio signal at each layer.

2. The method according to claim 1, wherein performing the feature extraction on the audio signal at the first layer to obtain the signal feature at the first layer comprises:
performing subband decomposition on the audio signal to obtain a low-frequency subband signal and a high-frequency subband signal of the audio signal;
performing feature extraction on the low-frequency subband signal at the first layer to obtain a low-frequency signal feature at the first layer, and performing feature extraction on the high-frequency subband signal at the first layer to obtain a high-frequency signal feature at the first layer; and
determining the low-frequency signal feature and the high-frequency signal feature as the signal feature at the first layer.

3. The method according to claim 2, wherein performing the subband decomposition on the audio signal to obtain the low-frequency subband signal and a high-frequency subband signal of the audio signal comprises:
sampling the audio signal according to first sampling frequency to obtain a sampled signal;
performing low-pass filtering on the sampled signal to obtain a low-pass filtered signal, and downsampling the low-pass filtered signal to obtain the low-frequency subband signal at second sampling frequency; and
performing high-pass filtering on the sampled signal to obtain a high-pass filtered signal, and downsampling the high-pass filtered signal to obtain the high-frequency subband signal at the second sampling frequency,
the second sampling frequency being less than the first sampling frequency.

4. The method according to claim 2, wherein splicing the audio signal and the signal feature at the (i-1)^{th} layer to obtain the spliced feature, and performing the feature extraction on the spliced feature at the i^{th} layer to obtain the signal feature at the i^{th} layer comprises:
splicing the low-frequency subband signal of the audio signal and a low-frequency signal feature at the (i-1)^{th} layer to obtain a first spliced feature, and performing feature extraction on the first spliced feature at the i^{th} layer to obtain a low-frequency signal feature at the i^{th} layer;
splicing the high-frequency subband signal of the audio signal and a high-frequency signal feature at the (i-1)^{th} layer to obtain a second spliced feature, and performing feature extraction on the second spliced feature at the i^{th} layer to obtain a high-frequency signal feature at the i^{th} layer; and
determining the low-frequency signal feature at the i^{th} layer and the high-frequency signal feature at the i^{th} layer as the signal feature at the i^{th} layer.

5. The method according to claim 1, wherein performing the feature extraction on the audio signal at the first layer to obtain the signal feature at the first layer comprises:
performing first convolution processing on the audio signal to obtain a convolution feature at the first layer;
performing first pooling processing on the convolution feature to obtain a pooled feature at the first layer;
performing first downsampling on the pooled feature to obtain a downsampled feature at the first layer; and
performing second convolution processing on the downsampled feature to obtain the signal feature at the first layer.

6. The method according to claim 5, wherein the first downsampling is performed by M cascaded coding layers, and performing the first downsampling on the pooled feature to obtain the downsampled feature at the first layer comprises:
performing the first downsampling on the pooled feature by a first coding layer among the M cascaded coding layers to obtain a downsampled result at the first coding layer;
performing the first downsampling on a downsampled result at a (j-1)^{th} coding layer by a j^{th} coding layer among the M cascaded coding layers to obtain a downsampled result at the j^{th} coding layer,
M and j being integers greater than 1, and j being less than or equal to M; and
traversing j to obtain a downsampled result at an M^{th} coding layer, and determining the downsampled result at the M^{th} coding layer as the downsampled feature at the first layer.

7. The method according to claim 1, wherein performing the feature extraction on the spliced feature at the i^{th} layer to obtain the signal feature at the i^{th} layer comprises:
performing third convolution processing on the spliced feature to obtain a convolution feature at the i^{th} layer;
performing second pooling processing on the convolution feature to obtain a pooled feature at the i^{th} layer;
performing second downsampling on the pooled feature to obtain a downsampled feature at the i^{th} layer; and
performing fourth convolution processing on the downsampled feature to obtain the signal feature at the i^{th} layer.

8. The method according to claim 1, wherein coding the signal feature at the first layer and the signal feature at each layer among the N layers separately to obtain the bitstream of the audio signal at each layer comprises:
quantizing the signal feature at the first layer and the signal feature at each layer among the N layers separately to obtain a quantized result of a signal feature at each layer; and
performing entropy coding on the quantized result of the signal feature at each layer to obtain the bitstream of the audio signal at each layer.

9. The method according to claim 1, wherein the signal feature comprises a low-frequency signal feature and a high-frequency signal feature, and coding the signal feature at the first layer and the signal feature at each layer among the N layers separately to obtain a bitstream of the audio signal at each layer comprises:
coding a low-frequency signal feature at the first layer and a low-frequency signal feature at each layer among the N layers separately to obtain a low-frequency bitstream of the audio signal at each layer;
coding a high-frequency signal feature at the first layer and a high-frequency signal feature at each layer among the N layers separately to obtain a high-frequency bitstream of the audio signal at each layer; and
determining the low-frequency bitstream and the high-frequency bitstream of the audio signal at each layer as a bitstream of the audio signal at a corresponding layer.

10. The method according to claim 1, wherein the signal feature comprises a low-frequency signal feature and a high-frequency signal feature, and coding the signal feature at the first layer and the signal feature at each layer among the N layers separately to obtain a bitstream of the audio signal at each layer comprises:
coding a low-frequency signal feature at the first layer according to a first coding bit rate to obtain a first bitstream at the first layer, and coding a high-frequency signal feature at the first layer according to a second coding bit rate to obtain a second bitstream at the first layer; and
performing the following processing separately for the signal feature at each layer among the N layers: coding the signal feature at each layer separately according to a third coding bit rate at each layer to obtain a second bitstream at each layer; and
determining the second bitstream at the first layer and the second bitstream at each layer among the N layers as the bitstream of the audio signal at each layer, and
the first coding bit rate being greater than the second coding bit rate, the second coding bit rate being greater than the third coding bit rate of any layer among the N layers, and a coding bit rate of the layer being positively correlated with a decoding quality indicator of a bitstream of a corresponding layer.

11. The method according to claim 1, wherein after the coding the signal feature at the first layer and the signal feature at each layer among the N layers separately to obtain a bitstream of the audio signal at each layer, the method further comprises:
performing the following processing separately for each layer:
configuring a corresponding layer transmission priority for the bitstream of the audio signal at the layer,
the layer transmission priority being negatively correlated with a layer level, and the layer transmission priority being positively correlated with a decoding quality indicator of a bitstream of a corresponding layer.

12. The method according to claim 1, wherein the signal feature comprises a low-frequency signal feature and a high-frequency signal feature, the bitstream of the audio signal at each layer comprises: a low-frequency bitstream obtained by coding based on the low-frequency signal feature and a high-frequency bitstream obtained by coding based on the high-frequency signal feature, and the method further comprises:
performing the following processing separately for each layer: configuring a first transmission priority for the low-frequency bitstream at the layer, and configuring a second transmission priority for the high-frequency bitstream at the layer,
the first transmission priority being higher than the second transmission priority, the second transmission priority at the (i-1)^{th} layer being lower than the first transmission priority at the i^{th} layer, and a transmission priority of the bitstream being positively correlated with a decoding quality indicator of a corresponding bitstream.

13. An electronic device, comprising:
one or more processors; and
a memory, configured to store executable instructions that, when being executed, cause the one or more processors to perform:
performing feature extraction on an audio signal at a first layer to obtain a signal feature at the first layer;
splicing, for an i^{th} layer among N layers, the audio signal and a signal feature at an (i-1)^{th} layer to obtain a spliced feature, and performing feature extraction on the spliced feature at the i^{th} layer to obtain a signal feature at the i^{th} layer, N and i being integers greater than 1, and i being less than or equal to N;
traversing i^{th} layers of the N layers to obtain a signal feature at each layer among the N layers, and a data dimension of the signal feature being less than a data dimension of the audio signal; and
coding the signal feature at the first layer and the signal feature at each layer among the N layers separately to obtain a bitstream of the audio signal at each layer.

14. The device according to claim 13, wherein the one or more processors are further configured to perform:
performing subband decomposition on the audio signal to obtain a low-frequency subband signal and a high-frequency subband signal of the audio signal;
performing feature extraction on the low-frequency subband signal at the first layer to obtain a low-frequency signal feature at the first layer, and performing feature extraction on the high-frequency subband signal at the first layer to obtain a high-frequency signal feature at the first layer; and
determining the low-frequency signal feature and the high-frequency signal feature as the signal feature at the first layer.

15. The device according to claim 14, wherein the one or more processors are further configured to perform:
sampling the audio signal according to first sampling frequency to obtain a sampled signal;
performing low-pass filtering on the sampled signal to obtain a low-pass filtered signal, and downsampling the low-pass filtered signal to obtain the low-frequency subband signal at second sampling frequency; and
performing high-pass filtering on the sampled signal to obtain a high-pass filtered signal, and downsampling the high-pass filtered signal to obtain the high-frequency subband signal at the second sampling frequency,
the second sampling frequency being less than the first sampling frequency.

16. The device according to claim 14, wherein the one or more processors are further configured to perform:
splicing the low-frequency subband signal of the audio signal and a low-frequency signal feature at the (i-1)^{th} layer to obtain a first spliced feature, and performing feature extraction on the first spliced feature at the i^{th} layer to obtain a low-frequency signal feature at the i^{th} layer;
splicing the high-frequency subband signal of the audio signal and a high-frequency signal feature at the (i-1)^{th} layer to obtain a second spliced feature, and performing feature extraction on the second spliced feature at the i^{th} layer to obtain a high-frequency signal feature at the i^{th} layer; and
determining the low-frequency signal feature at the i^{th} layer and the high-frequency signal feature at the i^{th} layer as the signal feature at the i^{th} layer.

17. The device according to claim 13, wherein the one or more processors are further configured to perform:
performing first convolution processing on the audio signal to obtain a convolution feature at the first layer;
performing first pooling processing on the convolution feature to obtain a pooled feature at the first layer;
performing first downsampling on the pooled feature to obtain a downsampled feature at the first layer; and
performing second convolution processing on the downsampled feature to obtain the signal feature at the first layer.

18. The device according to claim 17, wherein the first downsampling is performed by M cascaded coding layers, and the one or more processors are further configured to perform:
performing the first downsampling on the pooled feature by a first coding layer among the M cascaded coding layers to obtain a downsampled result at the first coding layer;
performing the first downsampling on a downsampled result at a (j-1)^{th} coding layer by a j^{th} coding layer among the M cascaded coding layers to obtain a downsampled result at the j^{th} coding layer,
M and j being integers greater than 1, and j being less than or equal to M; and
traversing j to obtain a downsampled result at an M^{th} coding layer, and determining the downsampled result at the M^{th} coding layer as the downsampled feature at the first layer.

19. The device according to claim 13, wherein the one or more processors are further configured to perform:
performing third convolution processing on the spliced feature to obtain a convolution feature at the i^{th} layer;
performing second pooling processing on the convolution feature to obtain a pooled feature at the i^{th} layer;
performing second downsampling on the pooled feature to obtain a downsampled feature at the i^{th} layer; and
performing fourth convolution processing on the downsampled feature to obtain the signal feature at the i^{th} layer.

20. A non-transitory computer-readable storage medium, having executable instructions stored thereon that, when being executed, cause the one or more processors to perform:
performing feature extraction on an audio signal at a first layer to obtain a signal feature at the first layer;
splicing, for an i^{th} layer among N layers, the audio signal and a signal feature at an (i-1)^{th} layer to obtain a spliced feature, and performing feature extraction on the spliced feature at the i^{th} layer to obtain a signal feature at the i^{th} layer, N and i being integers greater than 1, and i being less than or equal to N;
traversing i^{th} layers of the N layers to obtain a signal feature at each layer among the N layers, and a data dimension of the signal feature being less than a data dimension of the audio signal; and
coding the signal feature at the first layer and the signal feature at each layer among the N layers separately to obtain a bitstream of the audio signal at each layer.
